(19) United States
(12) Patent Application Publication
(10) Pub. No.: US 2025/0278770 A1
(43) Pub. Date: Sep. 4, 2025

(54) TECHNIQUES TO PERSONALIZE CONTENT USING MACHINE LEARNING

(71) Applicant: Adobe Inc., San Jose, CA (US)

(72) Inventor: Soumya Unnikrishnan, San Jose, CA (US)

(73) Assignee: Adobe Inc., San Jose, CA (US)

(21) Appl. No.: 18/592,044

(22) Filed: Feb. 29, 2024

(51) Int. Cl. G06Q 30/0601; G06Q 30/0204; G06Q 30/0251

(52) U.S. Cl. CPC G06Q 30/0631; G06Q 30/0204; G06Q 30/0251

(57) ABSTRACT

Techniques for personalizing multimedia content based on a knowledge graph are described. In one embodiment, a method includes receiving activity data associated with a user from a device, generating a touchpoint embedding and a decision embedding using a graph neural network (GNN) model based on the activity data, the GNN model trained using a knowledge graph, predicting a touchpoint using a first classifier based on the touchpoint embedding, predicting a decision stage using a second classifier based on the decision embedding, and generating personalized content for the touchpoint based on the decision stage using a large language model (LLM). Other embodiments are described and claimed.

### BACKGROUND

Data-driven analysis allows organizations to analyze data collections representing user characteristics and behavior to determine how users consider, evaluate, and purchase products and services. One kind of data is buyer journey data, which is data that represents various decision stages of a buying process that a user typically performs when buying a product or service. The buyer journey data includes touchpoints, each of which represent interactions between a user and an organization, such as a call or website click. Buyer journey data reveals how users think and behave as they traverse each decision stage of the buyer journey. Organizations use the buyer journey data to optimize delivery of services to assist buyers during their buyer journeys. Therefore, improvements to data-driven analysis of buyer journey data potentially benefits both users and organizations to make more informed decisions.

### SUMMARY

Embodiments are generally directed to artificial intelligence (AI) techniques to assist in data-driven analysis of buyer journey data. Some embodiments are particularly directed to using Al techniques to support a touchpoint content adaptation system. The touchpoint content adaptation system uses an AI system to encode knowledge from buyer decision journeys, infer a decision phase of a buyer and their next touchpoint, and deliver personalized multimedia content to the buyer in order to guide them to a next decision stage along the buyer decision journey. A touchpoint refers to an interaction or point of contact between a consumer and a brand or company, such as presenting multimedia content to the consumer on a website, for example. Embodiments seek to compress a classical buyer journey that a consumer-to-business (C2B) or business-to-business (B2B) buyer engages in by adapting and enriching touchpoint content in real-time that fulfills information needs for a buyer.

In one embodiment, for example, the touchpoint content adaptation system encodes knowledge from buyer decision journeys for ingest by a machine learning (ML) model. Further, the touchpoint content adaptation system uses an improved ML model trained to predict a decision phase of a buyer and their next touchpoint based on the buyer journey graph. The touchpoint content adaptation system generates, adapts, or personalizes multimedia content in real-time based on the predicted decision phase and/or their next touchpoint. The multimedia content comprises enriched content with supplemental information that aids a customer in a given decision phase.

In one embodiment, for example, the touchpoint content adaptation system encodes knowledge from buyer decision journeys in a buyer journey graph. The buyer journey graph is a special form of a knowledge graph that represents domain information relevant to a buyer decision journey. A knowledge graph is a structured representation of knowledge that captures relationships, concepts, entities, and their attributes in a graph-like format. This comprehensive and interconnected representation of knowledge is valuable for tasks such as semantic search, information retrieval, natural language processing, and advanced data analytics, providing a foundation for more sophisticated and intelligent applications and systems.

When using a buyer journey graph, the touchpoint content adaptation system uses an ML model such as a Graph Neural Network (GNN) model. A GNN is a type of neural network designed to operate on graph-structured data. Unlike traditional neural networks that operate on grid-like data such as images or sequences, GNNs are specifically tailored to handle data represented as graphs, where nodes and edges encapsulate entities and their relationships. GNNs are adept at capturing dependencies and relationships between entities in a graph, making them well-suited for tasks involving relational data, network analysis, social network modeling, and recommendations.

The touchpoint content adaption system encodes buyer decision journey data into the GNN model, which models the buyer journey graph from sources like time-series data from omni-channel touchpoints, transactional graphs, buyer characteristics, buyer persona, and so forth. Training of the GNN model encodes a new buyer's persona and behavior in a low-dimensional space. The GNN model generates two buyer embeddings for every user node in the buyer journey graph or a user node representing a new buyer. The first buyer embedding is a decision embedding that characterizes buyer-decision relations. The second buyer embedding is a touchpoint embedding that characterizes buyer-touchpoint relations. Downstream classifiers such as a decision stage inferencer and a touchpoint inferencer are designed to infer a decision stage of the user and the next touchpoint, respectively, using the buyer embeddings as features.

A touchpoint content adapter is a sub-system of the touchpoint content adaptation system. The touchpoint content adapter uses the downstream inferences and buyer embeddings to customize the touchpoint content. For example, a context orchestrator queries supplemental information through relevance scoring for the touchpoint, content, and buyer behavior to generate context information. Context information may comprise any information that provides a context for generating a multimedia message personalized for a user. A prompt builder constructs prompts specific to a given touchpoint and/or decision stage. The prompt builder then maps them to the generated context and content. A multi-model encoder/decoder, such as a larger language model (LLM), regenerates the content in the form of personalized content based on new context. The touchpoint content adapter dynamically updates the buyer journey graph and retrains encodings by including epochs that only optimize for added and removed parts. Online learning from shopper engagement feedback is used to tune context generation and prompt selection process to optimize a business metric or optimize a decision stage of the journey.

In one embodiment, for example, the touchpoint content adaptation system delivers the personalized multimedia content via one or more media channels to the buyer. The personalized multimedia content is specifically designed to guide, nudge, suggest, or otherwise enable a specific buyer or class of buyers to proceed to the next stage of the buyer decision journey. For example, the touchpoint content adaptation system uses a LLM to generate or personalize multimedia content for a buyer or class of buyers based on the predicted decision phase and/or next touchpoint. The LLM generates the personalized multimedia content with a certain tone, inflection, perspective, or other language characteristic that guides, nudges or suggests the buyer to proceed to a next stage in the buyer decision journey.

Any of the above embodiments may be implemented as instructions stored on a non-transitory computer-readable storage medium and/or embodied as an apparatus with a memory and a processor configured to perform the actions described above. It is contemplated that these embodiments may be deployed individually to achieve improvements in resource requirements and library construction time. Alternatively, any of the embodiments may be used in combination with each other in order to achieve synergistic effects, some of which are noted above and elsewhere herein.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a journey state machine in accordance with one embodiment.

FIG. 2 illustrates a knowledge graph in accordance with one embodiment.

FIG. 3 illustrates GNN system in accordance with one embodiment.

FIG. 4 illustrates touchpoint content adaptation system in accordance with one embodiment.

FIG. 5 illustrates a content delivery system in accordance with one embodiment.

FIG. 6 illustrates an inferencing system in accordance with one embodiment.

FIG. 7 illustrates a logic flow in accordance with one embodiment.

FIG. 8 illustrates a logic flow in accordance with one embodiment.

FIG. 9 illustrates an apparatus in accordance with one embodiment.

FIG. 10 illustrates an artificial intelligence architecture in accordance with one embodiment.

FIG. 11 illustrates an artificial neural network in accordance with one embodiment.

FIG. 12 illustrates a computer-readable storage medium in accordance with one embodiment.

FIG. 13 illustrates a computing architecture in accordance with one embodiment.

FIG. 14 illustrates a communications architecture in accordance with one embodiment.

### DETAILED DESCRIPTION

Embodiments are generally directed to artificial intelligence (AI) techniques to assist in data-driven analysis. Some embodiments are particularly directed to using AI techniques to support a touchpoint content adaptation system. The touchpoint content adaptation system uses an AI system to encode knowledge from buyer decision journeys, infer a decision phase of a buyer and their next touchpoint, and deliver personalized multimedia content with information to the buyer in order to facilitate proceeding to the next decision stage of the buyer decision journey. Embodiments seek to compress a classical buyer journey that a C2B or B2B buyer engages in by adapting and enriching touchpoint content in real-time that fulfills information needs for a buyer. Although exemplary embodiments are described in connection with a particular AI system, or machine learning (ML) model for an AI system, the principles described herein can also be applied to other types of AI systems as well. Embodiments are not limited in this context.

The buyer decision journey generally refers to a process that a consumer goes through before making a purchase. This journey typically involves several stages, including awareness of a need or desire, consideration of various options, evaluation of alternatives, and ultimately, the decision to make a purchase. Understanding the buyer decision journey can help organizations tailor their marketing efforts to effectively engage consumers at each stage of the process. One goal of the buyer decision journey is to have a consumer make a purchase and thereby enter a loyalty loop for the organization.

In the context of the buyer decision journey, a loyalty loop represents an ongoing relationship between a consumer and a brand or company. It encompasses a continuous cycle of engagement, purchase, satisfaction, and advocacy that can lead to repeat business and brand loyalty. The loyalty loop acknowledges that the buyer decision journey extends beyond the initial purchase, emphasizing the importance of nurturing and maintaining a positive connection with consumers to encourage future transactions and advocacy. By understanding and optimizing the loyalty loop, businesses can build lasting relationships with customers, drive repeat sales, and leverage word-of-mouth marketing to attract new consumers.

Along the buyer decision journey, a buyer and an organization (e.g., a company, business, university, governmental agency, etc.) may engage in various touchpoints. A touchpoint refers to any interaction or point of contact between a consumer and a brand or company, both online and offline. These touchpoints can include but are not limited to website visits, social media engagement, customer service interactions, product demonstrations, advertisements, and in-store experiences. Each touchpoint provides an opportunity for the brand to influence the buyer's decision-making process and shape their perception of the product or service. Understanding and mapping these touchpoints allows organizations to optimize their marketing and customer engagement strategies to create a cohesive and impactful buyer experience throughout the buyer decision journey.

ML models are often useful for predicting touchpoints for customers along the buyer decision journey. Historical data of accumulated buyer journeys is used to train a classifier. The trained classifier may infer or predict a next touchpoint for a buyer while the buyer decision journey is ongoing and still active. This gives an organization the ability to proactively provide support to the buyer at the predicted next touchpoint.

Conventional ML models for predicting touchpoints face several technical challenges. For example, a classifier typically uses a dataset to analyze input features and associated labels to learn a mapping from input data to a target output category. It uses statistical and algorithmic methods to build a model that can predict the category of new, unseen data based on the observed patterns in the training dataset. However, the classifier may become overly specialized to the training data, leading to poor generalization on new, unseen data. Conversely, the model may be too simplistic and fail to capture the complexities in the data, resulting in suboptimal performance. Further, class imbalance, where certain classes are underrepresented in the dataset, can lead to biased predictions and reduced accuracy for minority classes. In addition, high-dimensional datasets can lead to increased computational complexity and reduced classifier performance if the data is sparse or noisy. Also, feature engineering is difficult. Identifying and incorporating relevant features or transforming raw data into meaningful representations can be challenging, thereby impacting overall performance of a classifier.

Furthermore, predicting touchpoints for customers during the buyer decision journey, while useful, does not necessarily streamline the buyer decision journey. This is because the buyer decision journey is far more complex and non-linear than captured by conventional stages in the buyer decision journey. For example, different types of consumers engage in research, seek recommendations, and compare products or services across multiple channels before reaching a decision. Thus, the buyer decision journey is very different for each customer, varying by individual needs and preferences. Simply predicting a touchpoint for a given demographic or multiple customers is not particularly useful in guiding an individual buyer to the next stage in the buyer decision journey. In other words, a customer is not compelled along the buyer decision journey in a manner that leads to actually purchasing a product or service.

Embodiments attempt to solve these and other challenges. Exemplary embodiments are generally directed to improved AI techniques to assist in data-driven analysis. Some embodiments are particularly directed to using AI techniques to support a touchpoint content adaptation system. The touchpoint content adaptation system encodes knowledge from buyer decision journeys for ingest by a ML model. Further, the touchpoint content adaptation system uses an improved ML model trained to predict a decision phase of a buyer and their next touchpoint based on a domain-specific knowledge graph, referred to as a buyer journey graph. The touchpoint content adaptation system generates, adapts, or personalizes multimedia content in real-time based on the predicted decision phase and/or their next touchpoint. The multimedia content comprises enriched content with supplemental information that aids a customer in a given decision phase.

In one embodiment, for example, the touchpoint content adaptation system encodes knowledge from buyer decision journeys into a buyer journey graph. The buyer journey graph is a special form of a knowledge graph that represents domain information relevant to a buyer decision journey. A knowledge graph is a structured representation of knowledge that captures relationships, concepts, entities, and their attributes in a graph-like format. It organizes information in a way that emphasizes the connections between different data points, allowing for the representation of complex, interrelated knowledge in a coherent and accessible manner. A knowledge graph typically employs graph-based data structures where nodes represent entities or concepts, and edges denote the relationships between them. This allows for the creation of rich, contextual semantic networks that can be used to infer new information, support reasoning, and facilitate advanced data analysis and retrieval. In practical terms, a knowledge graph enables the integration of diverse data sources, the representation of domain-specific knowledge, and the ability to capture both explicit and implicit relationships between data points. This comprehensive and interconnected representation of knowledge is valuable for tasks such as semantic search, information retrieval, natural language processing, and advanced data analytics, providing a foundation for more sophisticated and intelligent applications and systems.

When using a buyer journey graph, the touchpoint content adaptation system uses an ML model designed to use graph-structured data, such as a Graph Neural Network (GNN). A GNN is a type of neural network designed to operate on graph-structured data. Unlike traditional neural networks that operate on grid-like data such as images or sequences, GNNs are specifically tailored to handle data represented as graphs, where nodes and edges encapsulate entities and their relationships. GNNs are adept at capturing dependencies and relationships between entities in a graph, making them well-suited for tasks involving relational data, network analysis, social network modeling, and recommendations. They can effectively propagate information across the graph structure, enabling the aggregation of local and global node features to generate insightful representations of the entire graph. GNNs have gained prominence in various domains including social networks, recommendation systems, bioinformatics, and knowledge graphs due to their ability to extract valuable insights from graph-structured data. These networks enable the modeling of complex relationships, support reasoning, and facilitate advanced analysis, contributing to their significance in contemporary machine learning research and applications.

In one embodiment, the touchpoint content adaptation system delivers the personalized multimedia content via one or more media channels to the buyer. The personalized multimedia content is specifically designed to guide, nudge, or enable a specific buyer or class of buyers to proceed to the next stage of the buyer decision journey. In one embodiment, for example, the touchpoint content adaptation system uses a large language model (LLM) to generate or personalize multimedia content for a buyer or class of buyers based on the predicted decision phase and/or next touchpoint. For example, the LLM generates the personalized multimedia content with a certain tone, inflection, perspective, or other language characteristic that guides, nudges or suggests the buyer to proceed to a next stage in the buyer decision journey.

The embodiments of the present disclosure represent significant improvements to conventional systems in a number of different ways. For example, as previously described, conventional systems use ML models such as classifiers typically rely on statistical and algorithmic methods to build a model that can predict the category of new, unseen data based on the observed patterns in the training dataset. However, conventional training datasets may introduce significant challenges such as overfitting, underfitting, class imbalance, computational complexity, feature engineering, and other problems that impact overall performance of a classifier. By way of contrast, embodiments encode buyer decision journey data in a knowledge graph. A GNN model receives as input samples from the knowledge graph, and it outputs buyer embeddings representing not only buyers but relationships for the buyers, including touchpoints, events, and other graph-structured data. Downstream classifiers are trained using the buyer embeddings generated by the knowledge graph, thereby leveraging the interconnected entities and relationships within the graph to extract rich semantic information and contextually relevant features. They can utilize the hierarchical and relational structure of the knowledge graph to incorporate more nuanced and comprehensive insights into the classification process, potentially capturing deeper contextual understanding and inferential reasoning.

Furthermore, conventional systems simply predict a touchpoint for a buyer along the buyer decision journey. They do not personalize content for the touchpoint. Embodiments seek to compress a classical buyer journey that a C2B or B2B buyer engages in by adapting and enriching touchpoint content in real-time that fulfills information needs for a buyer. In both C2B and B2B commerce, buyer decision journeys traverse through a myriad touchpoints before entering the loyalty loop. These touchpoints surface up content in diverse formats that seek to meet the buyer's information needs. Embodiments not only personalize touchpoint content according to buyer's preferences, but also extends the capability to enrich content to optimize next steps in a buyer's journey. Adapting content to meet the buyer at specific stages in the buyer journey can gently nudge the buyer to proceed to the next stage in the journey quickly. The optimization includes a particular tone and information that a buyer is seeking at a given point in their journey. Such adaptation of touchpoint content can deliver buyers directly into the loyalty loop and lock them within it.

Embodiments increase performance of a module, component, device, or system in a myriad of different ways. For example, the touchpoint content adaptation system and improved ML models can lead to higher prediction accuracy while reducing errors and improving overall performance, exhibit faster inference and learning times which enables quicker responses and better real-time performance in applications, facilitate scalable allowing them to handle larger datasets and increasing the potential for applications in big data scenarios, provide better generalization to unseen data making it more robust and reliable in real-world scenarios, improve feature extraction leading to more meaningful and informative representations of data, provide explainable AI (XAI) for better interpretability providing insights into their decision-making processes and enhancing transparency, fast adaptation to evolving data distributions and changing environments thereby increasing their applicability in dynamic settings, better regularization and generalization mitigating the risk of overfitting to training data, more efficient learning from data leading to faster convergence, reduced variance, improved stability, and resource efficiency such as requiring fewer computational resources, leading to more efficient use of hardware and decreased energy consumption. These and other advantages contribute to the overall effectiveness and reliability of devices or systems leveraging improved machine learning models, offering better performance, adaptability, and efficiency.

### Term Definitions

As used herein, the term “knowledge graph” refers to a structured representation of knowledge that captures information about entities (e.g., people, places, things, etc.) and the relationships between them. A knowledge graph is a type of knowledge base that uses a graph structure to organize data, where nodes represent entities (with associated properties) and edges represent relationships between these entities. Knowledge graphs store and represent knowledge in a way that is both human-readable and machine-understandable.

As used herein, the term “large language model” (LLM) refers to a neural network architecture. The LLM is trained on a diverse dataset comprising text from various sources, including knowledge graphs, examples of natural language queries, and corresponding graph-based representations (e.g., graph queries). The training process involves optimizing the model parameters to maximize its ability to understand and generate graph queries. The architecture of the LLM includes layers of neurons with weighted connections that enable the model to capture intricate language patterns.

As used herein, the term “graph neural network” refers to a type of neural network designed to operate on graph-structured data. Some examples of GNNs without limitation include: (1) Graph Convolutional Networks (GCNs) which are a fundamental type of GNN that operates on graph-structured data, leveraging convolutional operations to aggregate information from a node's neighborhood; (2) Graph Attention Networks (GATs) that utilize attention mechanisms to learn the importance of neighboring nodes during message passing, enabling them to focus on relevant information and adaptively aggregate node features; (3) Graph Sample and Aggregation (GraphSAGE) which is a technique that samples and aggregates features from a node's neighborhood to generate embeddings, allowing for scalable and efficient representation learning in large-scale graphs; (4) Graph Isomorphism Networks (GINs) designed to capture graph isomorphism, enabling them to learn invariant representations of graphs regardless of their specific node and edge permutations; and (5) Relational Graph Convolutional Networks (R-GCNs) tailored for learning in multi-relational graphs, allowing them to incorporate different types of edges and relationships between entities in the graph.

As used herein, the term “buyer journey graph” refers to a knowledge graph generated using domain specific information associated with informational stages, evaluation stages, and transactional stages, such as buyer journey data, user data, company data, business data, touchpoints, events, decision stages, transactions, user profile information, relationships, properties, attributes, or other graph-structured data.

As used herein, the term, “touchpoint inferencer” refers to a ML model or algorithm that is trained to predict or categorize input data into one or more predefined classes or categories based on its features. Examples of input data include touchpoint embeddings generated by a GNN system or GNN model.

As used herein, the term, “decision state inferencer” refers to a ML model or algorithm that is trained to predict or categorize input data into one or more predefined classes or categories based on its features. Examples of input data include decision embeddings generated by a GNN system or GNN model.

As used herein, the term, “touchpoint content adapter” refers to a system that receives as input touchpoint information and decision stage information, and outputs personalized content based on the touchpoint information and decision stage information.

Reference is now made to the drawings, wherein like reference numerals are used to refer to like elements throughout. In the following description, for purposes of explanation, numerous specific details are set forth in order to provide a thorough understanding thereof. However, the novel embodiments can be practiced without these specific details. In other instances, well known structures and devices are shown in block diagram form in order to facilitate a description thereof. The intention is to cover all modifications, equivalents, and alternatives consistent with the claimed subject matter.

In the Figures and the accompanying description, the designations “a” and “b” and “c” (and similar designators) are intended to be variables representing any positive integer. Thus, for example, if an implementation sets a value for a=5, then a complete set of components 121 illustrated as components 121-1 through 121-a may include components 121-1, 121-2, 121-3, 121-4, and 121-5. The embodiments are not limited in this context.

Operations for the disclosed embodiments may be further described with reference to the following figures. Some of the figures may include a logic flow. Although such figures presented herein may include a particular logic flow, it can be appreciated that the logic flow merely provides an example of how the general functionality as described herein can be implemented. Further, a given logic flow does not necessarily have to be executed in the order presented unless otherwise indicated. Moreover, not all operations illustrated in a logic flow may be required in some embodiments. In addition, a logic flow may be implemented by a hardware element, a software element executed by a processor, or any combination thereof. The embodiments are not limited in this context.

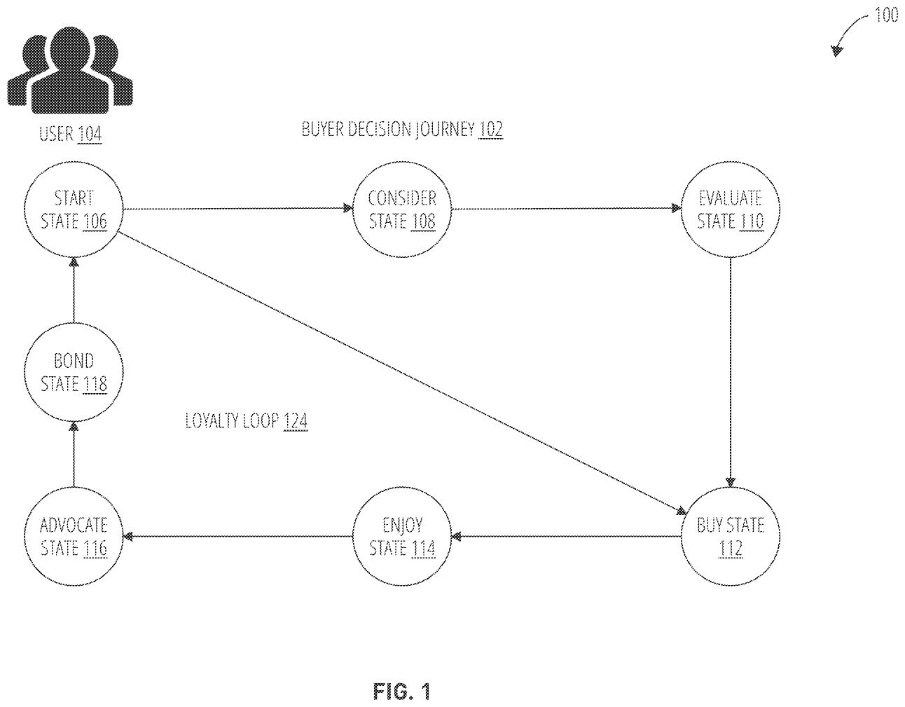

FIG. 1 illustrates a journey state machine 100. The journey state machine 100 comprises an example of different states, stages, or phases of a buyer decision journey 102 of a user 104 when purchasing a product or service from an organization, such as a business or business operator. For example, the journey state machine 100 may be used by a touchpoint content adaptation system using a ML model to predict, suggest, or infer a decision stage or a touchpoint for a decision stage in accordance with some embodiments.

As depicted in FIG. 1, the journey state machine 100 comprises a start state 106, a consider state 108, an evaluate state 110, and a buy state 112. The journey state machine 100 may further comprise a loyalty loop comprising the buy state 112, an enjoy state 114, an advocate state 116, and a bond state 118.

A user 104 may begin a buyer decision journey 102 at a start state 106. For example, the user 104 may seek to purchase a product or service from an entity, organization, company, business, or other type of entity.

The user 104 may enter a consider state 108. The consider state 108 of the buyer decision journey 102 refers to the phase in which the user 104 actively evaluates various options or alternatives to fulfill a specific need or desire. During this stage, the user 104 typically conducts research, compares products or services, and seeks out information to make an informed decision. This may involve reading reviews, gathering recommendations, exploring different features or specifications, and weighing the pros and cons of available choices. For businesses, understanding the consider state 108 is crucial for tailoring marketing efforts and providing relevant information to consumers to influence their decision-making process. Marketers often aim to present compelling value propositions and differentiated features to encourage consumers to consider their product or service as a viable solution. Helping consumers navigate this stage with relevant and persuasive content can significantly impact their eventual purchase decision.

After some period of time, the user 104 may exit the consider state 108 and enter the evaluate state 110. The evaluate state 110 of the buyer decision journey 102 is when a user 104 thoroughly assesses the various options identified during the consider state 108. In this stage, the consumer meticulously compares the attributes, features, and benefits of different products or services in order to make a well-informed decision. This evaluation process often involves detailed research, direct comparisons, and consideration of factors such as price, quality, reviews, and customer experiences. For businesses, understanding the evaluate stage is crucial for demonstrating the unique value and benefits of their offerings. It presents an opportunity to provide clear and compelling information that addresses consumers' specific needs and concerns, potentially influencing their decision in favor of a particular product or service. Businesses may seek to highlight key differentiators and competitive advantages during this stage to sway consumer preferences in their favor.

Assuming a favorable outcome of the evaluate state 110, the user 104 enters a buy state 112. The buy state 112 of the buyer decision journey 102 marks the point at which the user 104 makes the final decision to purchase a specific product or service. At this stage, the user 104 has completed the consider and evaluate phases, and has chosen a preferred option based on their research, comparison, and assessment of various alternatives. For businesses, the buy state 112 represents the pivotal moment when the user 104 becomes an actual customer. It is important for businesses to facilitate a smooth and frictionless purchasing process, whether it involves an online transaction, in-store purchase, or any other method of acquisition. Additionally, it provides an opportunity for businesses to reinforce buyer satisfaction, build positive post-purchase experiences, and potentially encourage repeat purchases or brand advocacy.

Once the user 104 buys a product or service from a company, the user 104 enters a loyalty loop 124 of the buyer decision journey 102. The loyalty loop 124 starts with a buy state 112, and proceeds through an enjoy state 114, advocate state 116, bond state 118, and a new start state 106, eventually proceeding to a new buy state 112.

Each of these states of the loyalty loop 124 in the buyer decision journey 102 represents the recurring cycle of consumer engagement, purchase, satisfaction, and advocacy that can lead to continued brand loyalty and repeat business. This model recognizes that the buyer decision journey 102 does not end with a single purchase, but rather continues as a continuous loop of engagement and interaction with the brand or product. In the loyalty loop 124, satisfied customers are not only likely to make repeat purchases but also to become advocates for the brand, promoting it to others and contributing to a positive brand image. This cycle of engagement, transaction, and advocacy can further strengthen the relationship between the user 104 and the brand, fostering long-term customer loyalty and potentially influencing others to engage with the brand as well. For businesses, recognizing and nurturing the loyalty loop 124 is important for fostering ongoing relationships with customers, as well as generating positive word-of-mouth referrals and building a loyal customer base that can drive sustained business success.

To this end, embodiments utilize a touchpoint content adaptation system to assist the user 104 in various decision stages of the buyer decision journey 102. The touchpoint content adaptation system uses an AI system with an ML model trained to predict touchpoints for the user 104 along the buyer decision journey 102. The touchpoint content adaptation system customizes or personalizes information for the user 104 at predicted touchpoints to facilitate progression through each of the decision stages of the buyer decision journey 102 to reach the buy state 112 in order to purchase a product or service from a business. This results in the user 104 entering the loyalty loop 124 which leads to the user 104 continuing to purchase products or services from the same business. In one embodiment, for example, the touchpoint content adaptation system utilizes a buyer journey graph, which is a form of a knowledge graph comprising information about the buyer decision journey 102, the loyalty loop 124, and the user 104, including relationships and other types of information.

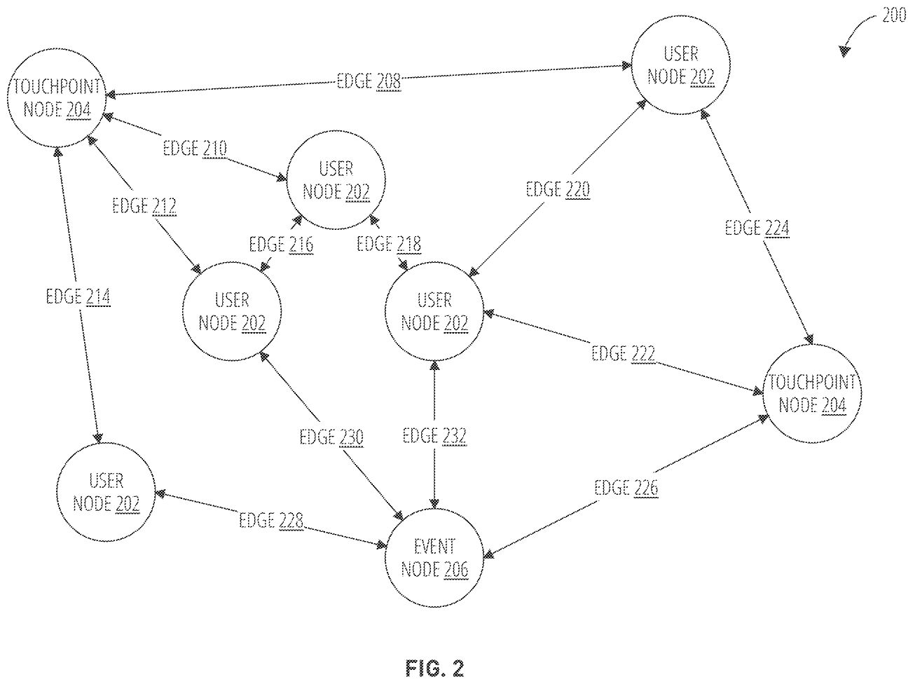

FIG. 2 depicts an example of a buyer journey graph 200. Graphs are a kind of data structure which models a set of objects (nodes) and their relationships (edges). Analyzing graphs with machine learning allows an AI system to take advantage of the great expressive power of graphs to denote large systems in different knowledge domains. As a unique non-Euclidean data structure for machine learning, graphs analysis focuses on tasks such as node classification, link prediction, and clustering. Graph neural networks (GNNs) are deep learning based methods that operate on graph domain, such as the buyer journey graph 200.

The buyer journey graph 200 comprises a plurality of nodes including one or more of a user node 202, a touchpoint node 204, and event node 206. The buyer journey graph 200 further includes a plurality of edges including an edge 208, edge 210, edge 212, edge 214, edge 216, edge 218, edge 220, edge 222, edge 224, edge 226, edge 228, edge 230, and edge 232. The numbers of edges and nodes in the buyer journey graph 200 should not be considered limiting of the disclosure, as the buyer journey graph 200 can have any number of nodes and/or any number of edges. Embodiments are not limited in these contexts.

The buyer journey graph 200 is representative of any type of a heterogenous knowledge graph with domain knowledge of the buyer journey graph 200 and associated entities. In some embodiments, the buyer journey graph 200 encodes information in a 3-tuple format. One example 3-tuple format is [head entity, relationship, tail entity]. Therefore, in the buyer journey graph 200, entities are represented by nodes, and the edges represent relationships between the entities connected via a given edge.

In one embodiment, as depicted in FIG. 2, the buyer journey graph 200 is an undirected graph. An undirected graph does not have any inherent direction to its edges. The connections between nodes are bidirectional, meaning that the relationship represented by an edge does not have a specific direction associated with it. In one embodiment, for example, the buyer journey graph 200 is directed graph, also known as a digraph, which is a type of graph in which the edges have a specific direction or orientation, meaning they go from one node to another. This directionality denotes a relationship of influence, flow, or causality between the nodes. Thus, a key difference between a directed graph and an undirected graph is the presence or absence of edge directionality, which impacts the interpretation of relationships between nodes within the graph.

A given node of the buyer journey graph 200 may correspond to any type of entity. In the example buyer journey graph 200, the user node 202 is associated with one or more consumers, such as the user 104. The touchpoint node 204 is associated with one or more touchpoints for a user 104. The event node 206 is associated with one or more events for a user 104.

Edges 208-232 define relationships between two given nodes. For example, edge 208, which connects user node 202 and touchpoint node 204, indicates one or more attributes for the user node 202 and/or the touchpoint node 204. In the context of a knowledge graph, an attribute refers to a characteristic or property associated with an entity or concept represented in the graph. Attributes provide additional descriptive information about the entities, enriching the knowledge representation and enabling more comprehensive analysis and reasoning. For example, in a knowledge graph related to e-commerce, product entities could have attributes such as price, brand, customer ratings, features, availability, and customer reviews. Similarly, customer entities might have attributes such as demographics, purchase history, preferences, and loyalty status. Attributes play a crucial role in building a detailed and nuanced representation of the entities within the knowledge graph, enabling effective query processing, data analysis, and inference. This in turn supports various applications such as recommendation systems, search, analytics, and decision support, facilitating a deeper understanding of the interconnected information within the graph. For example, the edge 208 may comprise a name attribute, such as a touchpoint name of the touchpoint node 204 and/or a name for the customer of user node 202.

In some embodiments, relationships defined by edges 208-232 have multiple hops. For example, a first relationship is defined by edge 208 and a second relationship is defined by edge 224. As such, a multiple hop relationship is defined by edges 208, 224. Embodiments are not limited in these contexts.

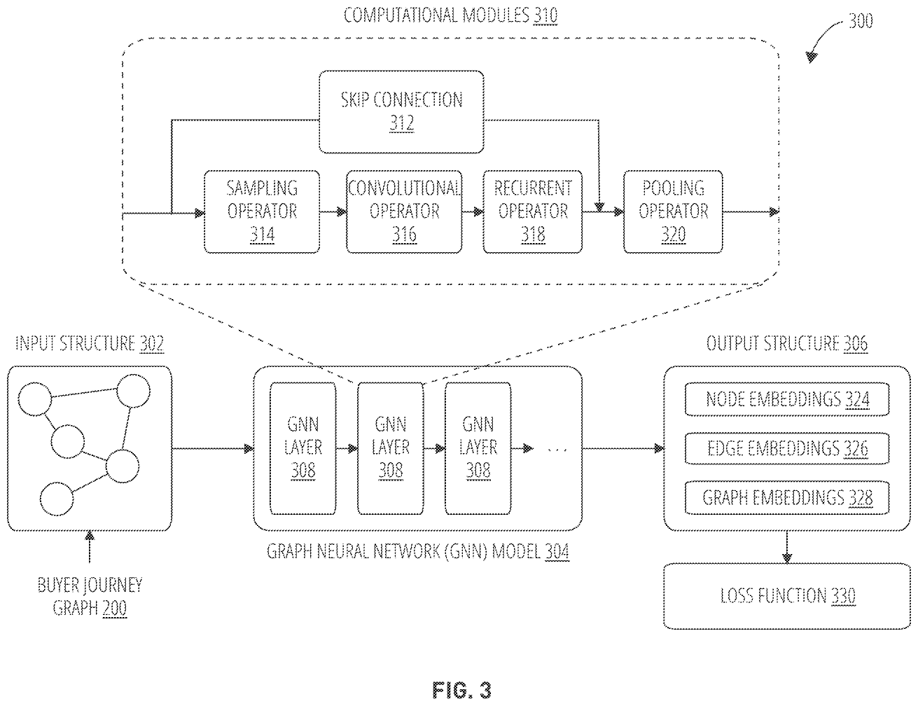

FIG. 3 illustrates a GNN system 300. The GNN system 300 comprises an exemplary AI system and ML model suitable for implementing various AI techniques as described herein for a touchpoint content adaptation system.

The GNN system 300 generally comprises several key components, which collectively enable the network to operate effectively on graph-structured data. Some of the fundamental components of a GNN system 300 include the representation of nodes as feature vectors, capturing the attributes or properties associated with each node in the graph, message passing mechanisms to propagate information across the graph thereby enabling the aggregation of neighboring nodes' features and the incorporation of relational information into the node representations, aggregation functions to combine and summarize information collected from neighboring nodes during the message passing process thereby generating aggregated representations for each node, an update function is used to update the node representations based on the aggregated information obtained from neighboring nodes thereby enabling the incorporation of the graph structure and relational dependencies, and an output function that processes the updated node representations to produce the final output, which may involve node classification, link prediction, graph classification, or other graph-based learning tasks. These components collectively enable GNN system 300 to effectively model and reason over graph-structured data, facilitating applications such as node classification, link prediction, graph embedding, and knowledge graph reasoning.

As depicted in FIG. 3, by way of example, the GNN system 300 comprises an input structure 302, a GNN model 304, and an output structure 306. An example of the input structure 302 comprises the buyer journey graph 200 as described with reference to FIG. 2. The output structure 306 comprises one or more embeddings (or vectors), such as one or more node embeddings 324, edge embeddings 326, and/or graph embeddings 328.

In the GNN model 304, node embeddings 324 refer to a vector representation that captures the essential features and characteristics of a node within the graph. Node embeddings 324 are obtained through the GNN's learning process, where the network iteratively updates and refines the representations of each node based on its neighborhood and the relationships with other nodes. The node embedding typically seeks to encode information about the node's structural, relational, and attribute-based properties, ensuring that the representation effectively captures the node's context within the graph. This allows the GNN model 304 to learn and utilize meaningful spatial representations that can facilitate various graph-based learning tasks such as node classification, link prediction, and graph analysis. Node embeddings 324 obtained from a well-trained GNN can serve as valuable feature representations, enabling downstream applications such as recommendation systems, graph clustering, and knowledge graph reasoning. The quality and effectiveness of the node embeddings strongly influence the GNN's overall performance in understanding and leveraging the complex network structures and relationships.

In the GNN model 304, edge embeddings 326 refer to a vector representation that captures the essential features and characteristics of the relationships between nodes in the graph. Similar to node embeddings 324, edge embeddings 326 are obtained through the GNN's learning process, which focuses on updating and refining the representations of edges based on the connected nodes and their interactions. The goal of edge embeddings 326 is to encode information about the structural, semantic, and contextual aspects of the relationships between nodes in the graph. By capturing pertinent information about the edges, the GNN model 304 can effectively learn and utilize meaningful representations that convey the nuanced interactions and dependencies within the graph. Edge embeddings 326 play a crucial role in various graph-based learning tasks, including link prediction, graph classification, and graph analysis. These representations enable the GNN model 304 to understand and model the rich relationships in the graph, facilitating accurate predictions and insightful analyses. High-quality edge embeddings 326 are important for the overall performance and effectiveness of the GNN model 304 in handling complex and interconnected graph data. They empower the network to comprehend the intricate graph structures and leverage the semantic relationships for diverse applications in graph-based machine learning.

In the GNN model 304, graph embeddings 328 refer to a vector representation that captures the essential features and characteristics of the entire graph. Unlike node embeddings 324 or edge embeddings 326, which focus on individual nodes or edges, graph embeddings 328 aim to encapsulate the collective properties and structural patterns of the entire graph. The graph embedding is obtained through the GNN's learning process, where the network iteratively updates and refines the representation to capture the global properties, relational dependencies, and semantic information present in the graph. It seeks to encode information about the graph's structure, topology, and meaningful interactions between nodes and edges. Graph embeddings 328 are valuable for tasks such as graph classification, graph clustering, and graph similarity measurement, where understanding the overall structural and relational patterns of the graph is crucial. By obtaining graph embeddings 328, the GNN model 304 can represent the entire graph in a high-dimensional vector space, facilitating downstream applications and analyses. A high-quality graph embedding empowers the GNN model 304 to effectively capture and reason over the complex relationships within the graph, providing valuable insights and enabling accurate predictions. This representation contributes to the GNN's capability to comprehend and leverage the global structural and relational information present in the graph, making it a powerful tool for graph-based machine learning tasks.

The GNN model 304 comprises one or more neural network layers, such as a GNN layer 308. In one embodiment, for example, the GNN model 304 is implemented as a Deep Neural Network (DNN). The classification of a network as a DNN is based on the presence of multiple hidden layers, allowing the network to perform complex feature extraction and hierarchical representation learning. The GNN model 304 leverages the deep learning paradigm to effectively capture and reason over complex relationships and dependencies within graph-structured data, allowing it to perform tasks such as node classification, link prediction, graph embedding, and knowledge graph reasoning. Therefore, GNNs are a specific type of DNN tailored to handle graph data and learn representations that capture the intricacies of interconnected entities within the graph.

A GNN layer 308 comprises multiple computational modules 310. The computational modules 310 include a skip connection 312, a sampling operator 314, a convolutional operator 316, a recurrent operator 318, and a pooling operator 320. The convolutional operator 316, recurrent operator 318, sampling operator 314, and skip connection 312 are part of a propagation model used to propagate information in each layer. The pooling operator 320 is then added to extract high-level information. The convolutional operator 316 generalizes convolutions from other domain to the graph domain using spectral approaches or spatial approaches. The recurrent operator 318, which can be used in addition to or as an alternative of the convolutional operator 316, aggregates information from neighbors in graphs. The pooling operator 320 extracts information from nodes from representations of high-level subgraphs or graphs. The sampling operator 314 is usually combined with the propagation model. The skip connection 312 gathers information from historical representations of nodes and mitigate against over-smoothing problems.

The GNN model 304 also includes a loss function 330. The loss function 330 serves as a measure of dissimilarity between the predicted output of the model and the true target output. The choice of a suitable loss function for the GNN model 304 depends on the specific task being addressed. Examples for the loss function 330 of the GNN model 304 includes a Mean Squared Error (MSE), Mean Absolute Error (MAE), Binary Cross-Entropy Loss, Categorical Cross-Entropy Loss, and Graph Distance-based Loss. These are merely a few examples of loss function 330, and the choice of a suitable loss function for the GNN model 304 may vary according to a specific learning objective of the GNN system 300 and the nature of the target variable.

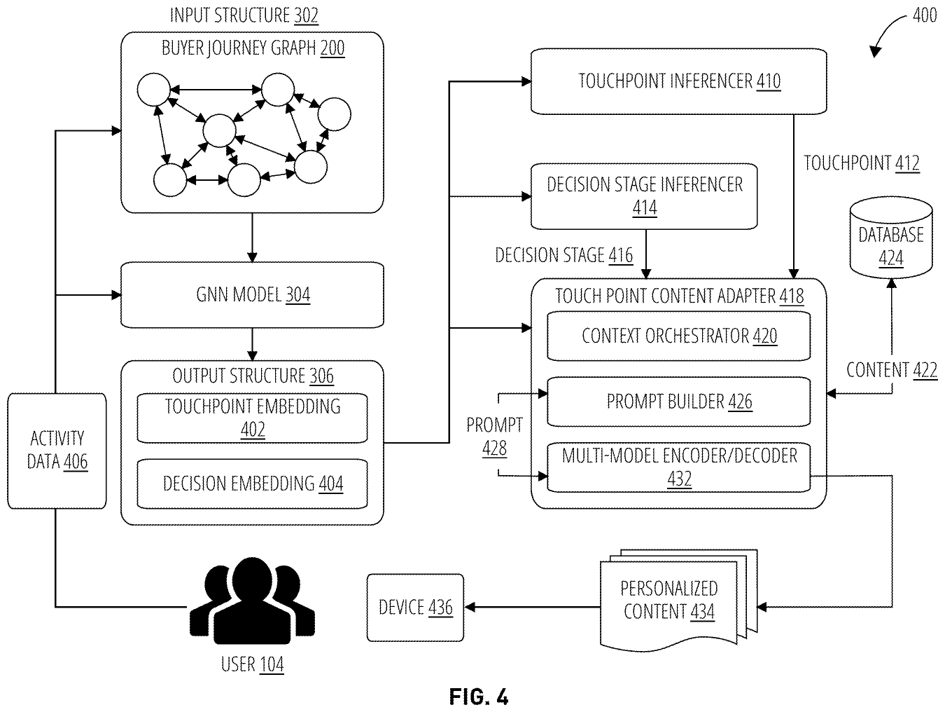

FIG. 4 illustrates a touchpoint content adaptation system 400. In various embodiments, for example, the touchpoint content adaptation system 400 implements the journey state machine 100, the buyer journey graph 200, and/or the GNN system 300. Embodiments are not limited to these examples.

The touchpoint content adaptation system 400 implements a buyer journey encoding model, generates inferences of a next touchpoint of the user 104 to identify content that requires optimization, and adapts the identified content in real-time by inferring where the user 104 is in the buyer decision journey 102. The touchpoint content adaptation system 400 enriches the identified content with supplemental information that aids the user 104 in a given decision stage. This includes modifying a tone of the content to nudge the user 104 to proceed to the next stage in the buyer decision journey 102.

The touchpoint content adaptation system 400 includes an input structure 302 comprising a buyer journey graph 200. As previously described, buyer journey data is encoded into a buyer journey graph 200 by combining information from sources such as omni-channel transaction graphs, application logs, session data, time-series data of touchpoints of buyers, and other data sources. The nodes in the graph represent buyers, touchpoints and events. A buyer refers to a user seeking to purchase a product or service. A touchpoint refers to an interaction between the buyer and an entity such as a business. An event refers to a decision stage of the journey state machine 100 or a transaction made by the buyer that infers a decision stage of the journey state machine 100. The node data comprises any activity data or user data such as journey metadata, buyer information, touchpoint content, actions, interactions, timestamps, demographics, user segments, marketing segments, and so forth.

The touchpoint content adaptation system 400 further includes a GNN model 304. During a training phase, the GNN model 304 is trained using a training dataset derived from the buyer journey graph 200. During each training iteration, the GNN model 304 takes as input structure 302 various sampled subgraphs from the buyer journey graph 200 to generate two types of embeddings comprising a touchpoint embedding 402 and a decision embedding 404. The touchpoint embedding 402 comprises a first set of node embeddings 324 and edge embeddings 326 representing relationships between a user node 202 and a touchpoint node 204, where the touchpoint node 204 represents a touchpoint for the user node 202. The decision embedding 404 comprises a second set of node embeddings 324 and edge embeddings 326 representing relationships between a user node 202 and an event node 206, where the event node 206 represents a decision stage in the buyer decision journey 102. The touchpoint embedding 402 and the decision embedding 404 are continuously compared to a ground truth (e.g., labeled embeddings) to determine differences. The loss function 330 and an optimization algorithm such as stochastic gradient descent are used to update various parameters (e.g., weights and biases) for the GNN model 304 based on the differences until training is complete.

In one embodiment, the GNN model 304 is trained in a self-supervised way using contrastive learning. In the context of machine learning, contrastive learning is a technique that focuses on learning representations of data by contrasting similar and dissimilar pairs. This approach involves training a model to pull together examples that share certain similarities, while pushing apart examples that are dissimilar. By doing so, the GNN model 304 learns to create embeddings that capture the intrinsic structure and relationships within the data, making it easier to distinguish between different categories or classes. Contrastive learning has gained attention for its ability to generate high-quality representations without requiring labeled data, thereby offering advantages in unsupervised learning scenarios. For example, the GNN model 304 is trained using contrastive learning, which pulls the touchpoint embedding 402 and decision embedding 404 of a given user node 202 and those that share edges with it together, while pushing apart the touchpoint embedding 402 and decision embedding 404 of the given user node 202 and a randomly selected, unconnected user node 202.

Once trained and tested, the GNN model 304 is deployed for inferencing operations. The GNN model 304 receives as input activity data 406 for a user 104. The activity data 406 comprises graph-structured data, including a user node 202 representing the user 104, a touchpoint node 204 (e.g., a previous touchpoint) for the user 104 (if known), an event node 206 (e.g., a decision stage) for the user 104 (if known), and any edges between the user node 202, touchpoint node 204, and/or event node 206. The trained GNN model 304 then generates a touchpoint embedding 402 and a decision embedding 404 for the user 104 based on the activity data 406. The touchpoint embedding 402 is output to a touchpoint inferencer 410. The decision embedding 404 is output to a decision stage inferencer 414.

Additionally or alternatively, the activity data 406 for the user 104 is encoded into the buyer journey graph 200. A new user node 202 is added to the buyer journey graph 200 with properties and attributes derived from the activity data 406. The GNN model 304 may be tuned to predict edges for the new user node 202 to various touchpoint nodes 204 or event nodes 206. The GNN model 304 generates touchpoint embedding 402 and decision embedding 404 based on the new user node 202, predicted edges, touchpoint nodes 204, and/or event nodes 206.

The touchpoint inferencer 410 is a classifier that receives as input the touchpoint embedding 402 and it predicts, suggest or infers a next touchpoint 412 for the user 104 based on the touchpoint embedding 402. In one embodiment, the touchpoint inferencer 410 is implemented using one or more multi-class classification models to perform the inferences such as inferring a next touchpoint 412 (e.g., catalog, banners, ads, conversational, etc.) of the user 104 to identify and adapt multimedia content to be activated for the user 104.

The decision stage inferencer 414 is a classifier that receives as input the decision embedding 404 and it predicts, suggest or infers a next decision stage 416 for the user 104 based on the decision embedding 404. In one embodiment, the touchpoint inferencer 410 is implemented using one or more multi-class classification models to perform the inferences such as inferring a next decision stage 416 of the user 104 to also assist in identifying and adapting the multimedia content to be activated for the user 104. In one embodiment, the decision stage inferencer 414 predicts one of three decision stages comprising an informational stage, comparative stage, or transactional stage. Each decision stage may correspond to the stages of the buyer decision journey 102 or the loyalty loop 124. For example, the informational stage may correspond to the consider state 108, the comparative stage to the evaluate state 110, and the transactional stage to the buy state 112. Embodiments are not limited to these example decision stages.

One example of a suitable ML model for the touchpoint inferencer 410 and the decision stage inferencer 414 is eXtreme Gradient Boosting (XGBoost) or XGBoost-like multi-class classification model. XGBoost is a machine learning algorithm known for its speed, performance, and versatility across regression, classification, and ranking problems. It belongs to the family of ensemble learning methods, specifically gradient boosting, and is widely used in data science and predictive modeling. XGBoost works by building a set of decision trees sequentially, where each new tree is trained to correct the errors of the combined model of existing trees. This iterative approach allows XGBoost to continuously improve its predictive accuracy. It incorporates advanced optimization and regularization techniques to prevent overfitting and handle missing data efficiently. The algorithm's popularity stems from its ability to handle large datasets, its flexibility in modeling complex, non-linear relationships, and its feature for handling both numerical and categorical data.

The touch point content adapter 418 is an omni-channel content adaptation system that comprises a context orchestrator 420, a prompt builder 426, and a multi-model encoder/decoder 432. The touch point content adapter 418 receives the touchpoint 412 from the touchpoint inferencer 410 and the decision stage 416 from the decision stage inferencer 414, and it outputs personalized content 434 for the user 104 based on the touchpoint 412 and the decision stage 416.

In one embodiment, for example, the context orchestrator 420 queries supplemental information through relevance scoring for the touchpoint, content, and buyer behavior to generate context information. Context information may comprise any information that provides a context for generating a multimedia message personalized for a user. For example, the context information may include the touchpoint, multimedia content templates, buyer information, buyer behavior, buyer metadata, buyer demographics, historical purchasing patterns, location information, user preferences, activity data, media channels, user groups, channel segments, clicks, web views, video views, pod casts, analytics, website information, web pages, transactions, and so forth. The content information allows the touchpoint content adapter to gather information about the user at a specific point in time during the buyer journey relevant to generating multimedia information for the consumer to assist in movement to a next stage in the buyer journey. Embodiments are not limited to these examples.

For example, the context orchestrator 420 queries supplemental content 422 specific to the decision stage 416 from vector data sources stored by a database 424. For example, when the decision stage 416 is an informational stage, the context orchestrator 420 queries content 422 such as information on product usage. When the decision stage 416 is a comparative stage, context orchestrator 420 queries content 422 such as price comparisons, with similar products or cross sell rules. When the decision stage 416 is a transaction stage, the context orchestrator 420 queries content 422 such as information on product pricing, taxes, delivery options, payment terms, and so forth. The content 422 is output to the prompt builder 426.

The prompt builder 426 generates a prompt 428 based on the decision stage 416 and touchpoint 412. The prompt 428 is an engineered input designed for requesting a certain type of output from the multi-model encoder/decoder 432. The multi-model encoder/decoder 432 is designed to regenerate the content 422 using the prompt 428. In one embodiment, the multi-model encoder/decoder 432 is an encoder and decoder (codec) for a ML model, such as a ML model used for generative AI.

In one embodiment, the prompt 428 is for a generative AI to produce the content 422 in a natural human language from a language model (LM) or large language model (LLM). A LLM is a type of AI designed to understand and generate human language at scale. In one embodiment, the prompt builder 426 generates a prompt 428 as a natural language prompt (NLP) suitable for an LLM. Some examples for LLM 430 includes without limitation a Generative Pre-trained Transformer (GPT), a Bidirectional Encoder Representations from Transformers (BERT), Robustly optimized BERT approach (ROBERTa) which is a modified version of BERT, Turing Natural Language Generation (Turing-NLG), XLNet, and other types of LLMs. The prompt builder 426 crafts specific input prompts 428 for the LLM to generate desired outputs using prompt engineering techniques. Prompt engineering attempts to construct the prompt 428 in a way that elicits accurate and contextually relevant responses from the LLM, taking full advantage of its language generation capabilities.

In one embodiment, the prompt builder 426 generates a prompt 428 in a way that causes the LLM to generate information or a message with a certain tone. The tone of information or a message refers to the attitude or emotion expressed by the sender through their choice of words, phrasing, and overall communication style. It conveys the underlying feelings, intentions, and mood of the sender, which can greatly influence how the message is interpreted by the recipient. The tone of a message can be formal, casual, friendly, authoritative, persuasive, empathetic, humorous, academic, assertive, or a combination of these and other emotions or attitudes. Understanding the tone of a message is important because it can impact the way the message is received and the emotional response it elicits from the user 104. For example, a formal and respectful tone may be appropriate in professional contexts, while a warm and friendly tone may be used in social interactions. Similarly, a persuasive tone might be employed in marketing messages, while a compassionate tone may be suitable for consoling or empathizing with someone. In written communication, the tone of a message can be conveyed through word choice, sentence structure, punctuation, and even the use of emoticons or emojis. It plays a key role in effective communication, helping to establish rapport, convey empathy, instill confidence, and achieve the desired emotional impact on the recipient. When interpreting a message, understanding the intended tone can help to grasp the full meaning and nuance behind the communicated words, thereby facilitating clearer and more effective communication between parties.

For example, when the prompt builder 426 receives a decision stage 416 that is an informational stage, and it generates a prompt 428 to produce multimedia content (e.g., text, images, sounds, vibrations, etc.) in a human language for a given country in a casual or friendly tone. When the prompt builder 426 receives a decision stage 416 that is a comparative stage, it generates a prompt 428 to produce multimedia content (e.g., text, images, sounds, vibrations, etc.) in a human language for a given country in an authoritative and persuasive tone. When the prompt builder 426 receives a decision stage 416 that is a transactional stage, and it generates a prompt 428 to produce multimedia content (e.g., text, images, sounds, vibrations, etc.) in a human language for a given country in a formal tone. In one embodiment, for example, the prompt builder 426 maps a prompt to content 422 from the context orchestrator 420. For example, the prompt builder 426 maps a prompt 428 that modifies a tone of a banner text to engage the user 104 doing a comparative research on products. These are merely a few examples, and the prompt builder 426 generates prompts 428 with various types of tones depending on the user 104, the content 422, the decision stage 416, the touchpoint 412, the company, and other factors relevant to marketing and sales of products and services to the user 104. Embodiments are not limited in this context.

In one embodiment, the prompt builder 426 uses the buyer encodings to select among different prompts 428 through a relevancy scoring process. In one embodiment, the relevancy scoring process may score the relevancy of products or services according to a set of user preferences and past interactions with a company, such as through encodings of metadata for the user 104 during a loyalty loop 124, thereby enabling personalized recommendations. For example, the relevancy scoring process may be implemented using a scoring algorithm such as cosine similarity, logistic regression, random forest, gradient boosting, or other scoring algorithms. Embodiments are not limited to these examples.

Once the multi-model encoder/decoder 432 adapts the content 422 in response to the prompt 428, it outputs personalized content 434 for the user 104. The touch point content adapter 418 then forwards the personalized content 434 at the touchpoint 412 for presentation on an electronic display of an electronic device 436.

The buyer journey graph 200 is updated dynamically with new journeys and old buyer embeddings are retrained by interleaving with epochs during which only the updated journey nodes are optimized. This results in faster performance using fewer technical resources (e.g., compute, memory, bandwidth, power, etc.) relative to a complete retraining of the GNN model 304.

In this manner, a content adaptation process is optimized in an online fashion using reinforcement learning. This is done by using buyer engagement as feedback to tune the context orchestrator 420 and the prompt builder 426 to generate optimal contexts and prompts that improve a business metric or shorten a specific decision stage for the user 104.

The touch point content adapter 418 is a system that encodes a buyer's journey into the GNN model 304, which models the buyer journey graph 200 from sources like time-series data from omni-channel touchpoints, transactional graphs, buyer characteristics, buyer persona, and so forth. Training of the GNN model 304 encodes a new buyer's persona and behavior in a low-dimensional space. The GNN model 304 generates two embeddings of every user node 202, including a decision embedding 404 that characterizes buyer-decision relations and a touchpoint embedding 402 that characterizes buyer-touchpoint relations. Downstream classifiers such as touchpoint inferencer 410 and decision stage inferencer 414 are designed to infer a decision stage 416 of the user 104 and the next touchpoint 412, respectively, using the buyer embeddings as features. A touch point content adapter 418 uses downstream inferences and buyer embeddings to customize the touchpoint content 422. Context orchestrator 420 queries supplemental information through relevance scoring for the touchpoint 412, content 422, and buyer behavior to generate context. A prompt builder 426 uses touchpoint 412 and decision stage 416 specific prompts and maps them to the generated context and content. A multi-model encoder/decoder 432, such as an LLM, regenerates content in the form of personalized content 434 based on new context. The touch point content adapter 418 dynamically updates the buyer journey graph 200 and retrains encodings by including epochs that only optimize for added and removed parts. Online learning from shopper engagement feedback is used to tune context generation and prompt selection process to optimize a business metric or optimize a decision stage of the journey.

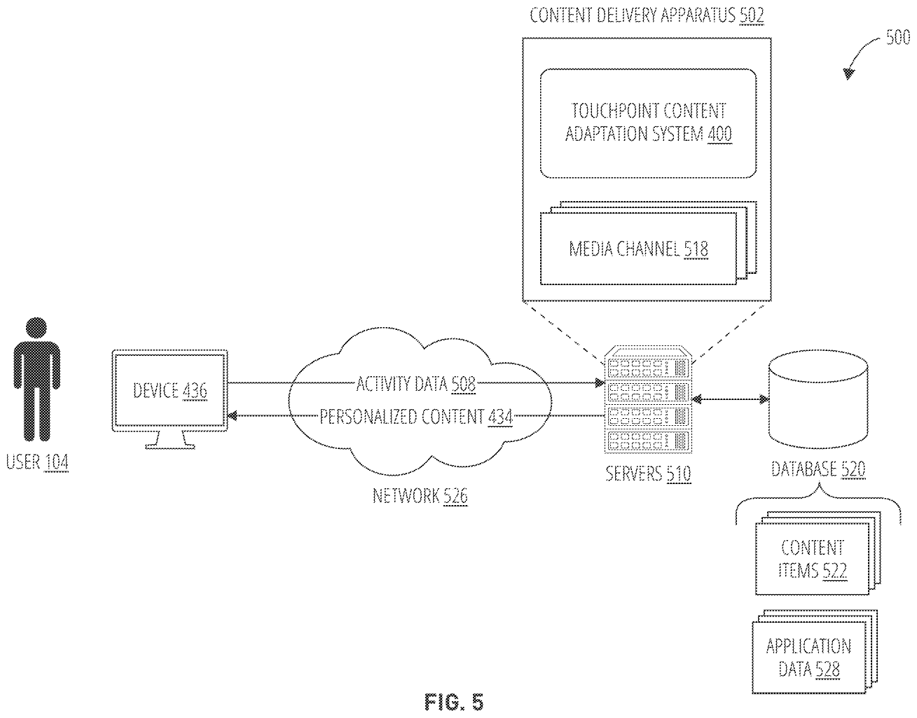

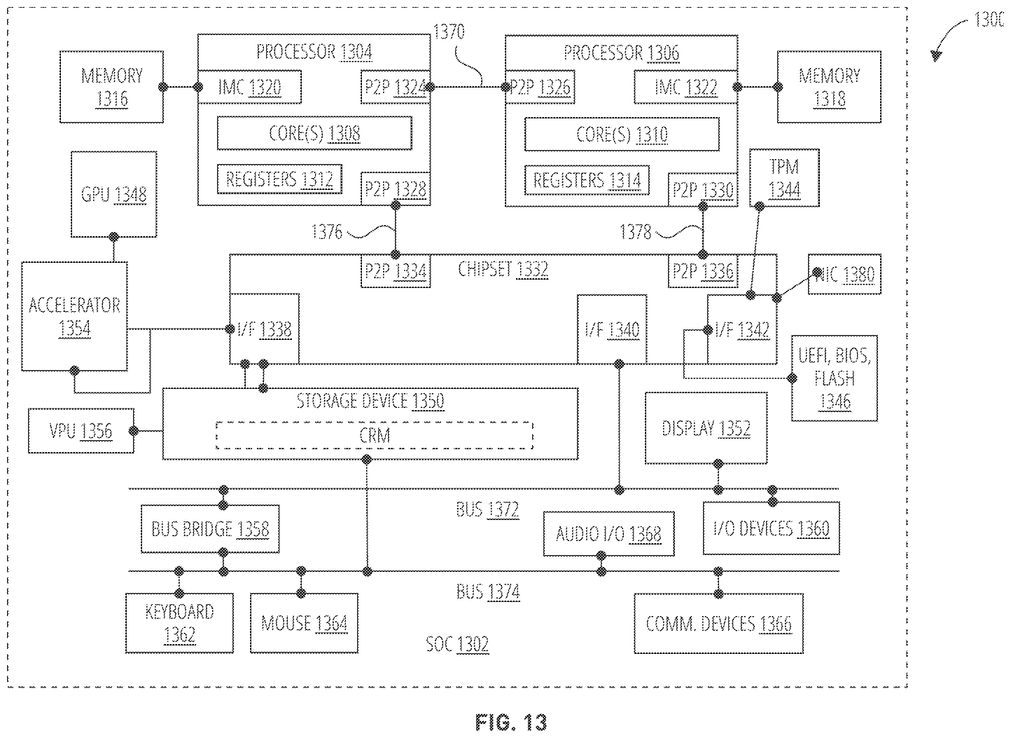

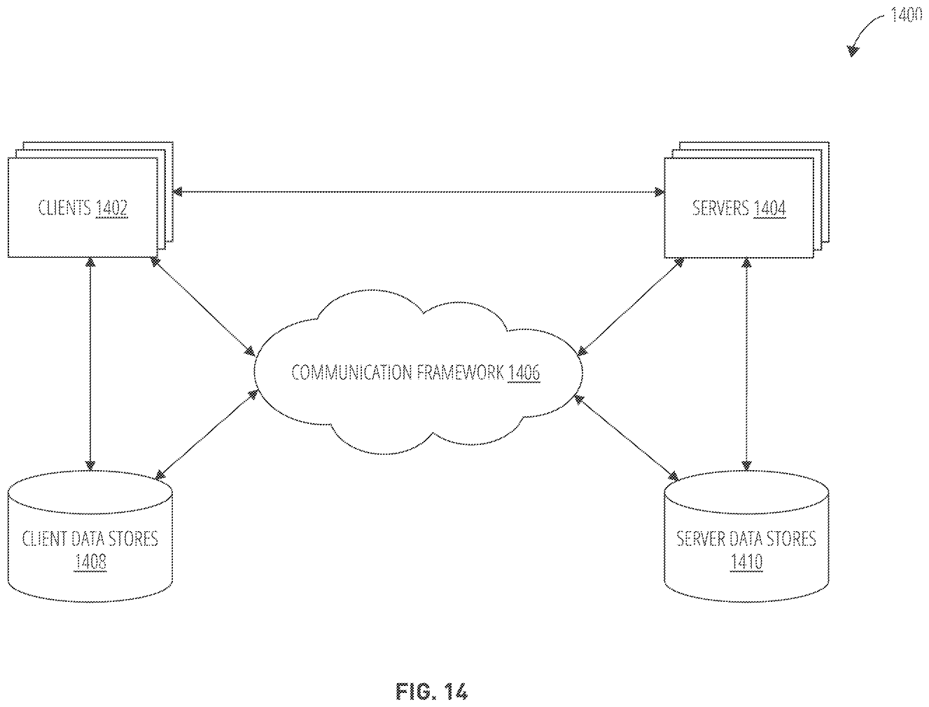

FIG. 5 illustrates a content delivery system 500. The content delivery system 500 is an example of a system designed to deliver targeted content to one or more users according to aspects of the present disclosure. The content delivery system 500 comprises a device 436, a set of one or more servers 510, and a database 520. The device 436 and the servers 510 may communicate information via a network 526. The device 436 may comprise an electronic device, such as a smartwatch, smartphone, tablet, laptop computer, desktop computer, and so forth. The servers 510 may be implemented as part of a data center, such as a cloud computing system. The device 436 and the servers 510 may be implemented using an architecture as described in FIG. 13. The network 526 may be implemented using an architecture as described in FIG. 14. Embodiments are not limited to these example implementations.

The one or more servers 510 implements a content delivery apparatus 502. In one embodiment, the content delivery apparatus 502 includes at least one processor; at least one memory including instructions executable by the at least one processor; and a machine learning model comprising parameters stored in the at least one memory, wherein the machine learning model comprises a GNN model 304.

The servers 510 may include content delivery apparatus 502 implementing touch point content adaptation system 400 that is designed for performing targeted content delivery. In an example process, the content delivery apparatus 502 obtains activity data 508 from a user 104 via the device 436. The user 104 interacts with the content delivery apparatus 502 via a user interface of the content delivery apparatus 502. In some cases, portions of the user interface are displayed on a personal machine or device 436 of the user 104. The activity data 508 represents various actions, activities or behaviors of the user 104. For example, activity data 508 may represent data collected as the user 104 interacts with content items 522 of the database 424 served via the servers 510. Session data is any activity data 508 collected during a defined session time window, such as activity of the user over a 24 h period or some other time interval. For example, the user 104 may interact with the device 436 to communicate with content delivery apparatus 502 of one or more of the servers 510 to access one or more content items 522 stored by the database 424. The user 104 may perform various activities, such as browsing a web site, watching a streaming video, or engaging in electronic commerce. The session data, including the activity data 508, is transferred between the device 436 and the servers 510.

More particularly, the content delivery apparatus 502 comprises the touchpoint content adaptation system 400, which includes an ML model such as GNN model 304, and data for one or more media channels 518. The touchpoint content adaptation system 400 coordinates operations for the content delivery apparatus 502. For example, the touchpoint content adaptation system 400 is responsible for creation of personalized content 434 based on activity data 508 and/or session data associated with the user 104. The touchpoint content adaptation system 400 then targets delivery of segment specific messages to users within user segments, such as personalized content 434 for the user 104, over one or more media channels 518. The personalized content 434 is a content item that is relevant to the user 104 or a user segment, such as messages, predictions, recommendations, advertisements, or suggestions to improve user experience.

The personalized content 434 is delivered through one or more of the media channels 518. A media channel refers to a specific platform or medium through which targeted content, such as advertisements, are disseminated to a target user. Media channels 518 can include various forms of digital and traditional media such as websites, mobile applications, social media platforms, television, radio, print publications, and outdoor advertising spaces. Each media channel possesses its own unique characteristics and user demographics, allowing advertisers to tailor their messages to reach the desired target user effectively. message provider, such as advertisers, often choose certain media channels based on factors such as user engagement, reach, cost, and the compatibility of the channel with their target market. An example of the media channel 518 is a social media platform, such as Google or Meta, or some other mode of information transfer within the platform.

The content delivery apparatus 502 or components thereof are implemented on a server. A server provides one or more functions to users linked by way of one or more of the various networks. In some cases, the server includes a single microprocessor board, which includes a microprocessor responsible for controlling all aspects of the server. In some cases, a server uses microprocessor and protocols to exchange data with other devices/users on one or more of the networks via hypertext transfer protocol (HTTP), and simple mail transfer protocol (SMTP), although other protocols such as file transfer protocol (FTP), and simple network management protocol (SNMP) can also be used. In some cases, a server is configured to send and receive hypertext markup language (HTML) formatted files (e.g., for displaying web pages). In various embodiments, a server comprises a general purpose computing device, a personal computer, a laptop computer, a mainframe computer, a super computer, or any other suitable processing apparatus.

Database 520 is an organized collection of data. For example, the database 520 stores data in a specified format known as a schema. The database 520 can be structured as a single database, a distributed database, multiple distributed databases, or an emergency backup database. In some cases, a database controller manages data storage and processing in database 520. In some cases, a user interacts with the database controller. In other cases, the database controller operates automatically without user interaction. The database 520 is configured to store various content items 522. The content items 522 include any multimedia information suitable for presentation by the device 436, such as HTML code to present websites, text, images, video, messages, advertisements, and so forth. In addition, the database 520 may store application data 528. The application data 528 comprises information and data used by the content delivery apparatus 502. For example, database 520 is configured to store user session data, profiles, embeddings, budgets, cached application programming interface (API) requests, machine learning model parameters, training data, and other data.

Network 526 facilitates the transfer of information between content delivery apparatus 502, database 520, and user 104. Network 526 is a computer network configured to provide on-demand availability of computer system resources, such as data storage and computing power. In some examples, the network 526 provides resources without active management by the user 104. The network 526 includes data centers available to many users over the Internet. Some large cloud networks have functions distributed over multiple locations from central servers. A server is designated an edge server if it has a direct or close connection to a user 104. In some cases, a cloud is limited to a single organization. In other examples, the cloud is available to many organizations. In one example, the network 526 includes a multi-layer communications network comprising multiple edge routers and core routers. In another example, the network 526 is based on a local collection of switches in a single physical location.

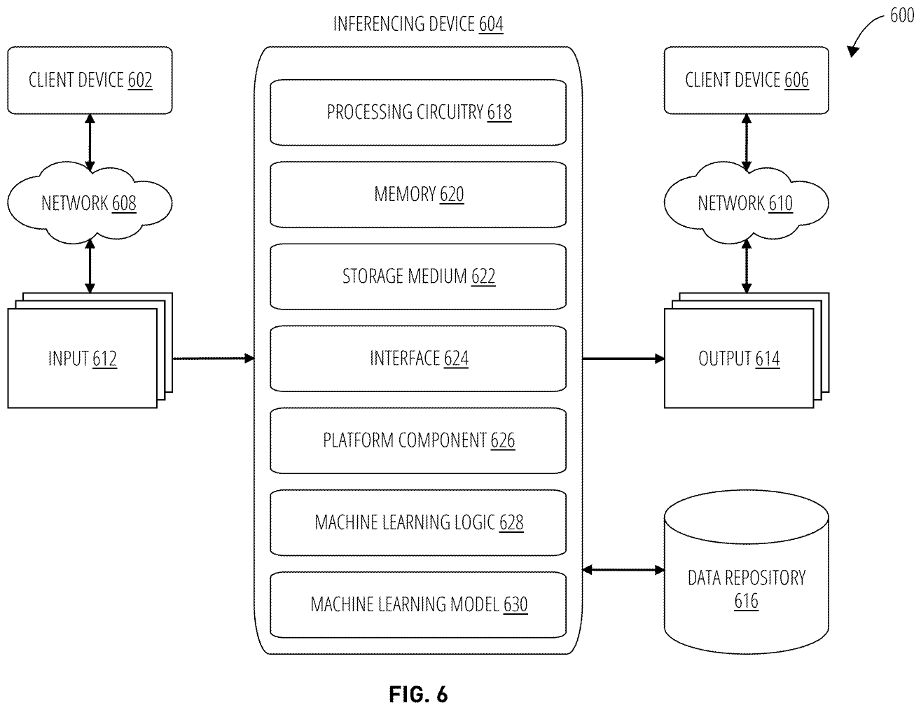

FIG. 6 illustrates an embodiment of a system 600. The system 600 is suitable for implementing one or more embodiments as described herein. In one embodiment, for example, the system 600 is an AI/ML system suitable for implementing the journey state machine 100, buyer journey graph 200, GNN system 300, touchpoint content adaptation system 400, and/or content delivery system 500.

The system 600 comprises a set of M devices, where M is any positive integer. FIG. 6 depicts three devices (M=3), including a client device 602, an inferencing device 604, and a client device 606. The inferencing device 604 communicates information with the client device 602 and the client device 606 over a network 608 and a network 610, respectively. The information may include input 612 from the client device 602 and output 614 to the client device 606, or vice-versa. In one alternative, the input 612 and the output 614 are communicated between the same client device 602 or client device 606. In another alternative, the input 612 and the output 614 are stored in a data repository 616. In yet another alternative, the input 612 and the output 614 are communicated via a platform component 626 of the inferencing device 604, such as an input/output (I/O) device (e.g., a touchscreen, a microphone, a speaker, etc.).

As depicted in FIG. 6, the inferencing device 604 includes processing circuitry 618, a memory 620, a storage medium 622, an interface 624, a platform component 626, ML logic 628, and an ML model 630. In some implementations, the inferencing device 604 includes other components or devices as well. Examples for software elements and hardware elements of the inferencing device 604 are described in more detail with reference to a computing architecture 1300 as depicted in FIG. 13. Embodiments are not limited to these examples.

The inferencing device 604 is generally arranged to receive an input 612, process the input 612 via one or more AI/ML techniques, and send an output 614. The inferencing device 604 receives the input 612 from the client device 602 via the network 608, the client device 606 via the network 610, the platform component 626 (e.g., a touchscreen as a text command or microphone as a voice command), the memory 620, the storage medium 622 or the data repository 616. The inferencing device 604 sends the output 614 to the client device 602 via the network 608, the client device 606 via the network 610, the platform component 626 (e.g., a touchscreen to present text, graphic or video information or speaker to reproduce audio information), the memory 620, the storage medium 622 or the data repository 616. Examples for the software elements and hardware elements of the network 608 and the network 610 are described in more detail with reference to a communications architecture 1400 as depicted in FIG. 14. Embodiments are not limited to these examples.

The inferencing device 604 includes ML logic 628 and an ML model 630 to implement various AI/ML techniques for various AI/ML tasks. The ML logic 628 receives the input 612, and processes the input 612 using the ML model 630. The ML model 630 performs inferencing operations to generate an inference for a specific task from the input 612. In some cases, the inference is part of the output 614. The output 614 is used by the client device 602, the inferencing device 604, or the client device 606 to perform subsequent actions in response to the output 614.

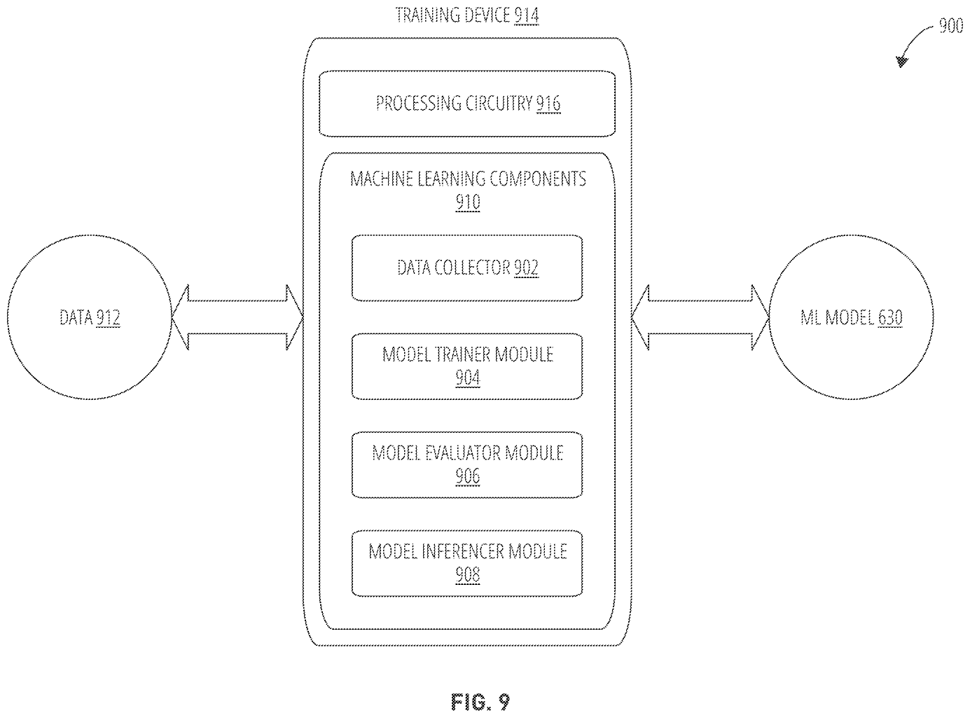

In various embodiments, the ML model 630 is a trained ML model 630 using a set of training operations. An example of training operations to train the ML model 630 is described with reference to FIG. 9.

Operations for the disclosed embodiments are further described with reference to the following figures. Some of the figures include a logic flow. Although such figures presented herein include a particular logic flow, the logic flow merely provides an example of how the general functionality as described herein is implemented. Further, a given logic flow does not necessarily have to be executed in the order presented unless otherwise indicated. Moreover, not all acts illustrated in a logic flow are required in some embodiments. In addition, the given logic flow is implemented by a hardware element, a software element executed by one or more processing devices, or any combination thereof. The embodiments are not limited in this context.

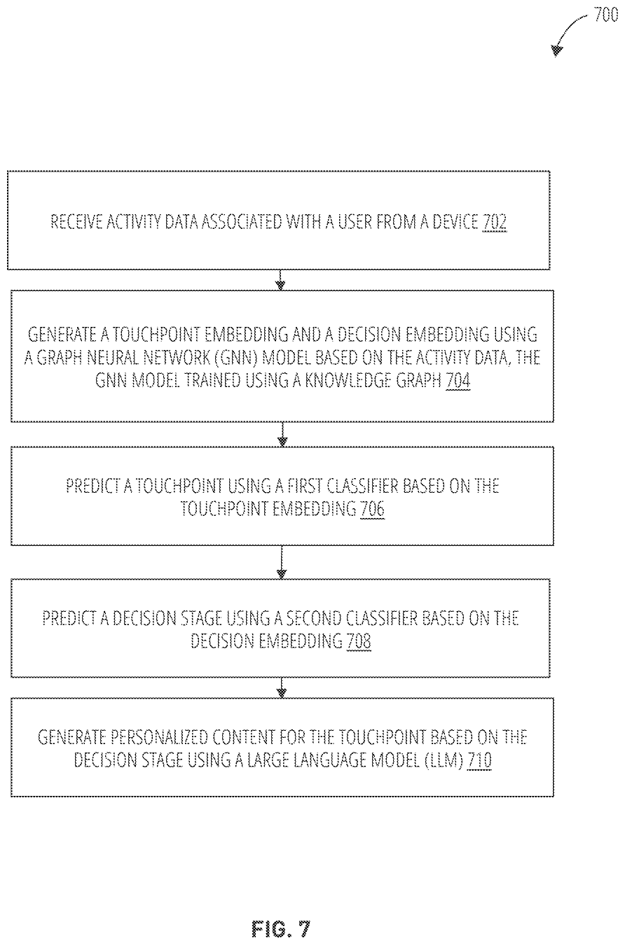

FIG. 7 illustrates an embodiment of a logic flow 700. The logic flow 700 is representative of some or all of the operations executed by one or more embodiments described herein. For example, the logic flow 700 includes some or all of the operations performed by devices or entities within the system 600 or the apparatus 900. In one embodiment, the logic flow 700 is implemented as instructions stored on a non-transitory computer-readable storage medium, such as the storage medium 622, that when executed by the processing circuitry 618 causes the processing circuitry 618 to perform the described operations. The storage medium 622 and processing circuitry 618 may be co-located, or the instructions may be stored remotely from the processing circuitry 618. Collectively, the storage medium 622 and the processing circuitry 618 may form a system.

In block 702, the logic flow 700 receives activity data associated with a user from a device. In block 704, the logic flow 700 generates a touchpoint embedding and a decision embedding using a graph neural network (GNN) model based on the activity data, the GNN model trained using a knowledge graph. In block 706, the logic flow 700 predicts a touchpoint using a first classifier based on the touchpoint embedding. In block 708, the logic flow 700 predicts a decision stage using a second classifier based on the decision embedding. In block 710, the logic flow 700 generates personalized content for the touchpoint based on the decision stage using a large language model (LLM).

By way of example, the touchpoint content adaptation system 400 receives activity data 406 associated with a user 104 from a device 436. A GNN model 304 generates a touchpoint embedding 402 and a decision embedding 404 based on the activity data 406. The GNN model 304 is trained using a knowledge graph, such as buyer journey graph 200, for example. The touchpoint inferencer 410 predicts a touchpoint 412 based on the touchpoint embedding 402 for the user 104. The decision stage inferencer 414 predicts a decision stage 416 based on the decision embedding 404 for the user 104. The touch point content adapter 418 generates personalized content 434 for the touchpoint 412 based on context information such as the decision stage 416 using the multi-model encoder/decoder 432. In one embodiment, the multi-model encoder/decoder 432 is implemented as a LLM such as a GPT. The touch point content adapter 418 forwards the personalized content 434 to the device 436 to present the personalized content 434 for the touchpoint 412 on an electronic display of the device 436.

The touchpoint content adapter 418 is a sub-system of the touchpoint content adaptation system 400. The touchpoint content adapter 418 uses the downstream inferences and buyer embeddings to customize the touchpoint content. The touch point content adapter 418 includes the context orchestrator 420 to retrieve content 422 from a database 424 based on the touchpoint 412 and the decision stage 416. The prompt builder 426 constructs a prompt 428 for the multi-model encoder/decoder 432 (e.g., an LLM) to regenerate the content 422. The multi-model encoder/decoder 432 generates and outputs the personalized content 434 based on the regenerated content from the LLM.

In one embodiment, for example, the context orchestrator 420 queries supplemental information through relevance scoring for the touchpoint, content, and buyer behavior to generate context information. Context information may comprise any information that provides a context for generating a multimedia message personalized for a user. For example, the context information may include the touchpoint, multimedia content templates, buyer information, buyer behavior, buyer metadata, buyer demographics, historical purchasing patterns, location information, user preferences, activity data, media channels, user groups, channel segments, clicks, web views, video views, pod casts, analytics, website information, web pages, transactions, and so forth. The content information allows the touchpoint content adapter to gather information about the user at a specific point in time during the buyer journey relevant to generating multimedia information for the consumer to assist in movement to a next stage in the buyer journey. Embodiments are not limited to these examples.

In one embodiment, the activity data 406 is graph-structured data for the knowledge graph, such as the buyer journey graph 200. The graph-structured data comprises a user node 202 (e.g., a buyer node), a touchpoint node 204, an event node 206, and a set of edges between the user node 202, the touchpoint node 204, and the event node 206.

In one embodiment, the touchpoint embedding 402 is a vector comprising values representing a relationship between a user node 202, a touchpoint node 204, and an edge between the user node 202 and the touchpoint node 204. The edge may comprise a directional or bi-directional edge.

In one embodiment, the decision embedding 404 is a vector comprising values representing a relationship between a user node 202, an event node 206, and an edge between the user node 202 and the event node 206. The edge may comprise a directional or bi-directional edge.

In one embodiment, the touchpoint content adaptation system 400 detects a transaction associated with the user 104 from the device 436, such as from updated activity data 406. The touchpoint content adaptation system 400 updates the knowledge graph, such as buyer journey graph 200, with graph-structured data based on the activity data 406 associated with the user 104 after the transaction.

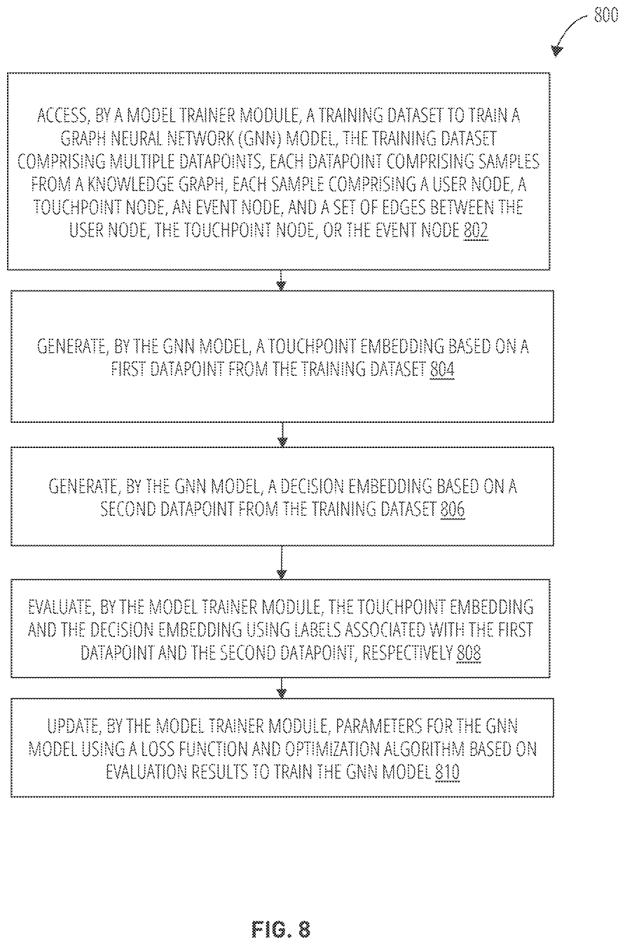

FIG. 8 illustrates an embodiment of a logic flow 800. The logic flow 800 is representative of some or all of the operations executed by one or more embodiments described herein. For example, the logic flow 800 includes some or all of the operations performed by devices or entities within the system 600 or the apparatus 900. In one embodiment, the logic flow 800 is implemented as instructions stored on a non-transitory computer-readable storage medium, such as the storage medium 622, that when executed by the processing circuitry 618 causes the processing circuitry 618 to perform the described operations. The storage medium 622 and processing circuitry 618 may be co-located, or the instructions may be stored remotely from the processing circuitry 618. Collectively, the storage medium 622 and the processing circuitry 618 may form a system.

In block 802, logic flow 800 accesses, by a model trainer module, a training dataset to train a graph neural network (GNN) model, the training dataset includes multiple datapoints, each datapoint includes samples from a knowledge graph, each sample includes a user node, a touchpoint node, an event node, and a set of edges between the user node, the touchpoint node, or the event node. In block 804, logic flow 800 generates, by the GNN model, a touchpoint embedding based on a first datapoint from the training dataset. In block 806, logic flow 800 generates, by the GNN model, a decision embedding based on a second datapoint from the training dataset. In block 808, logic flow 800 evaluates, by the model trainer module, the touchpoint embedding and the decision embedding using labels associated with the first datapoint and the second datapoint, respectively. In block 810, logic flow 800 updates, by the model trainer module, parameters for the GNN model using a loss function and optimization algorithm based on evaluation results to train the GNN model.

By way of example, a model trainer module 904 accesses a training dataset comprising testing data 1028 to train a GNN model 304. The training dataset includes multiple datapoints, each datapoint includes samples from a knowledge graph, such as buyer journey graph 200. Each sample includes a user node 202, a touchpoint node 204, an event node 206, and a set of edges between the user node 202, the touchpoint node 204, or the event node 206. The GNN model 304 generates a touchpoint embedding 402 based on a first datapoint from the training dataset. The GNN model 304 generates a decision embedding 404 based on a second datapoint from the training dataset. The model trainer module 904 evaluates the touchpoint embedding 402 and the decision embedding 404 using labels associated with the first datapoint and the second datapoint, respectively. The model trainer module 904 modifies parameters (e.g., weights, biases, activation functions, etc.) for the GNN model 304 using a loss function 330 and optimization algorithm based on evaluation results to train the GNN model 304.

In one embodiment, the touchpoint embedding 402 includes a vector with values representing a relationship between a user node 202, a touchpoint node 204, and an edge between the user node 202 and the touchpoint node 204.

In one embodiment, the decision embedding 404 includes a vector with values representing a relationship between a user node 202, an event node 206, and an edge between the user node 202 and the event node 206.

In one embodiment, a model evaluator module 906 tests or evaluates the trained GNN model 304 using a testing dataset comprising testing data 1028 that includes datapoints to test the GNN model 304.

In one embodiment, model trainer module 904 re-trains the trained GNN model 304 using feedback information, such as feedback 1018 from the model evaluator module 906 or the model inferencer module 908.

In one embodiment, the touchpoint content adaptation system 400 detects a transaction from activity data 406 associated with a user 104 from a device 436. The touchpoint content adaptation system 400 encodes the knowledge graph, such as buyer journey graph 200, with a new user node 202 representing the user 104, a new event node 206 representing the transaction, and a new edge between the new user node 202 and the new event node 206, generating a new datapoint for the training dataset. The model trainer module 904 re-trains the GNN model 304 using the new datapoint.

FIG. 9 illustrates an apparatus 900. The apparatus 900 depicts a training device 914 suitable to generate a trained ML model 630 for the inferencing device 604 of the system 600. As depicted in FIG. 9, the training device 914 includes a processing circuitry 916 and a set of ML components 910 to support various AI/ML techniques, such as a data collector 902, a model trainer module 904, a model evaluator module 906 and a model inferencer module 908.

In general, the data collector 902 collects data 912 from one or more data sources to use as training data for the ML model 630. The data collector 902 collects different types of data 912, such as text information, audio information, image information, video information, graphic information, and so forth. The model trainer module 904 receives as input the collected data and uses a portion of the collected data as test data for an AI/ML algorithm to train the ML model 630. The model evaluator module 906 evaluates and improves the trained ML model 630 using a portion of the collected data as test data to test the ML model 630. The model evaluator module 906 also uses feedback information from the deployed ML model 630. The model inferencer module 908 implements the trained ML model 630 to receive as input new unseen data, generate one or more inferences on the new data, and output a result such as an alert, a recommendation or other post-solution activity.

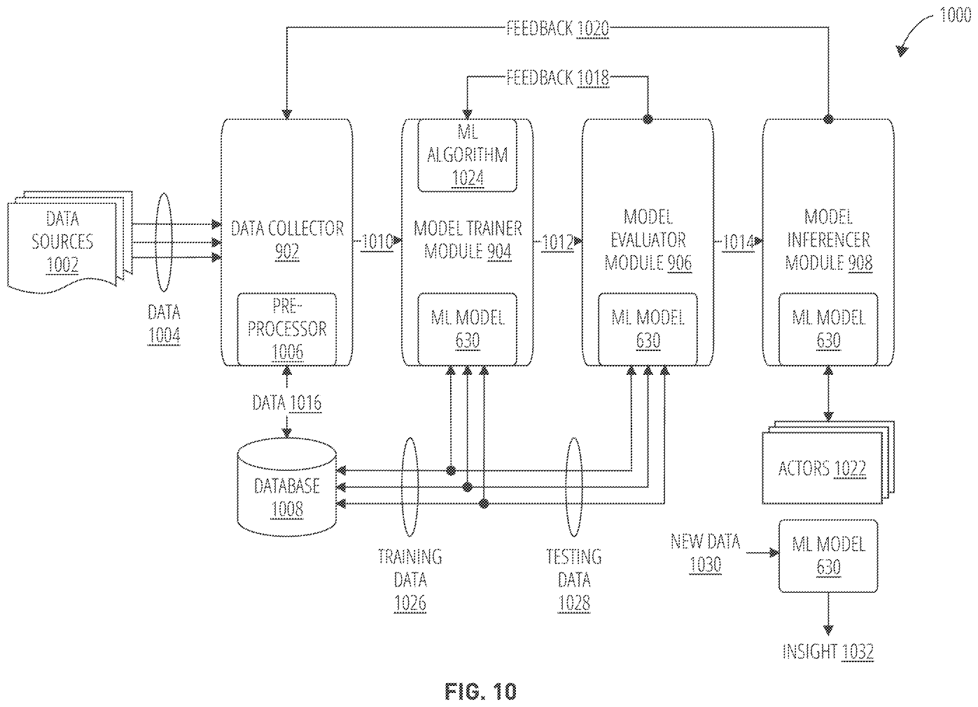

An exemplary AI/ML architecture for the ML components 910 is described in more detail with reference to FIG. 10.

FIG. 10 illustrates an artificial intelligence architecture 1000 suitable for use by the training device 914 to generate the ML model 630 for deployment by the inferencing device 604. The artificial intelligence architecture 1000 is an example of a system suitable for implementing various AI techniques and/or ML techniques to perform various inferencing tasks on behalf of the various devices of the system 600.

AI is a science and technology based on principles of cognitive science, computer science and other related disciplines, which deals with the creation of intelligent machines that work and react like humans. AI is used to develop systems that can perform tasks that require human intelligence such as recognizing speech, vision and making decisions. AI can be seen as the ability for a machine or computer to think and learn, rather than just following instructions. ML is a subset of AI that uses algorithms to enable machines to learn from existing data and generate insights or predictions from that data. ML algorithms are used to optimize machine performance in various tasks such as classifying, clustering and forecasting. ML algorithms are used to create ML models that can accurately predict outcomes.

In general, the artificial intelligence architecture 1000 includes various machine or computer components (e.g., circuit, processor circuit, memory, network interfaces, compute platforms, input/output (I/O) devices, etc.) for an AI/ML system that are designed to work together to create a pipeline that can take in raw data, process it, train an ML model 630, evaluate performance of the trained ML model 630, and deploy the tested ML model 630 as the trained ML model 630 in a production environment, and continuously monitor and maintain it.

The ML model 630 is a mathematical construct used to predict outcomes based on a set of input data. The ML model 630 is trained using large volumes of training data 1026, and it can recognize patterns and trends in the training data 1026 to make accurate predictions. The ML model 630 is derived from an ML algorithm 1024 (e.g., a neural network, decision tree, support vector machine, etc.). A data set is fed into the ML algorithm 1024 which trains an ML model 630 to “learn” a function that produces mappings between a set of inputs and a set of outputs with a reasonably high accuracy. Given a sufficiently large enough set of inputs and outputs, the ML algorithm 1024 finds the function for a given task. This function may even be able to produce the correct output for input that it has not seen during training. A data scientist prepares the mappings, selects and tunes the ML algorithm 1024, and evaluates the resulting model performance. Once the ML logic 628 is sufficiently accurate on test data, it can be deployed for production use.

The ML algorithm 1024 may comprise any ML algorithm suitable for a given AI task. Examples of ML algorithms may include supervised algorithms, unsupervised algorithms, or semi-supervised algorithms.

A supervised algorithm is a type of machine learning algorithm that uses labeled data to train a machine learning model. In supervised learning, the machine learning algorithm is given a set of input data and corresponding output data, which are used to train the model to make predictions or classifications. The input data is also known as the features, and the output data is known as the target or label. The goal of a supervised algorithm is to learn the relationship between the input features and the target labels, so that it can make accurate predictions or classifications for new, unseen data. Examples of supervised learning algorithms include: (1) linear regression which is a regression algorithm used to predict continuous numeric values, such as stock prices or temperature; (2) logistic regression which is a classification algorithm used to predict binary outcomes, such as whether a customer will purchase or not purchase a product; (3) decision tree which is a classification algorithm used to predict categorical outcomes by creating a decision tree based on the input features; or (4) random forest which is an ensemble algorithm that combines multiple decision trees to make more accurate predictions.

An unsupervised algorithm is a type of machine learning algorithm that is used to find patterns and relationships in a dataset without the need for labeled data. Unlike supervised learning, where the algorithm is provided with labeled training data and learns to make predictions based on that data, unsupervised learning works with unlabeled data and seeks to identify underlying structures or patterns. Unsupervised learning algorithms use a variety of techniques to discover patterns in the data, such as clustering, anomaly detection, and dimensionality reduction. Clustering algorithms group similar data points together, while anomaly detection algorithms identify unusual or unexpected data points. Dimensionality reduction algorithms are used to reduce the number of features in a dataset, making it easier to analyze and visualize. Unsupervised learning has many applications, such as in data mining, pattern recognition, and recommendation systems. It is particularly useful for tasks where labeled data is scarce or difficult to obtain, and where the goal is to gain insights and understanding from the data itself rather than to make predictions based on it.

Semi-supervised learning is a type of machine learning algorithm that combines both labeled and unlabeled data to improve the accuracy of predictions or classifications. In this approach, the algorithm is trained on a small amount of labeled data and a much larger amount of unlabeled data. The main idea behind semi-supervised learning is that labeled data is often scarce and expensive to obtain, whereas unlabeled data is abundant and easy to collect. By leveraging both types of data, semi-supervised learning can achieve higher accuracy and better generalization than either supervised or unsupervised learning alone. In semi-supervised learning, the algorithm first uses the labeled data to learn the underlying structure of the problem. It then uses this knowledge to identify patterns and relationships in the unlabeled data, and to make predictions or classifications based on these patterns. Semi-supervised learning has many applications, such as in speech recognition, natural language processing, and computer vision. It is particularly useful for tasks where labeled data is expensive or time-consuming to obtain, and where the goal is to improve the accuracy of predictions or classifications by leveraging large amounts of unlabeled data.

The ML algorithm 1024 of the artificial intelligence architecture 1000 is implemented using various types of ML algorithms including supervised algorithms, unsupervised algorithms, semi-supervised algorithms, or a combination thereof. A few examples of ML algorithms include support vector machine (SVM), random forests, naive Bayes, K-means clustering, neural networks, and so forth. A SVM is an algorithm that can be used for both classification and regression problems. It works by finding an optimal hyperplane that maximizes the margin between the two classes. Random forests is a type of decision tree algorithm that is used to make predictions based on a set of randomly selected features. Naive Bayes is a probabilistic classifier that makes predictions based on the probability of certain events occurring. K-Means Clustering is an unsupervised learning algorithm that groups data points into clusters. Neural networks is a type of machine learning algorithm that is designed to mimic the behavior of neurons in the human brain. Other examples of ML algorithms include a support vector machine (SVM) algorithm, a random forest algorithm, a naive Bayes algorithm, a K-means clustering algorithm, a neural network algorithm, an artificial neural network (ANN) algorithm, a convolutional neural network (CNN) algorithm, a recurrent neural network (RNN) algorithm, a long short-term memory (LSTM) algorithm, a deep learning algorithm, a decision tree learning algorithm, a regression analysis algorithm, a Bayesian network algorithm, a genetic algorithm, a federated learning algorithm, a distributed artificial intelligence algorithm, and so forth. Embodiments are not limited in this context.

As depicted in FIG. 10, the artificial intelligence architecture 1000 includes a set of data sources 1002 to source data 1004 for the artificial intelligence architecture 1000. Data sources 1002 may comprise any device capable generating, processing, storing or managing data 1004 suitable for a ML system. Examples of data sources 1002 include without limitation databases, web scraping, sensors and Internet of Things (IoT) devices, image and video cameras, audio devices, text generators, publicly available databases, private databases, and many other data sources 1002. The data sources 1002 may be remote from the artificial intelligence architecture 1000 and accessed via a network, local to the artificial intelligence architecture 1000 an accessed via a network interface, or may be a combination of local and remote data sources 1002.

The data sources 1002 source difference types of data 1004. By way of example and not limitation, the data 1004 includes structured data from relational databases, such as customer profiles, transaction histories, or product inventories. The data 1004 includes unstructured data from websites such as customer reviews, news articles, social media posts, or product specifications. The data 1004 includes data from temperature sensors, motion detectors, and smart home appliances. The data 1004 includes image data from medical images, security footage, or satellite images. The data 1004 includes audio data from speech recognition, music recognition, or call centers. The data 1004 includes text data from emails, chat logs, customer feedback, news articles or social media posts. The data 1004 includes publicly available datasets such as those from government agencies, academic institutions, or research organizations. These are just a few examples of the many sources of data that can be used for ML systems. It is important to note that the quality and quantity of the data is critical for the success of a machine learning project.

The data 1004 is typically in different formats such as structured, unstructured or semi-structured data. Structured data refers to data that is organized in a specific format or schema, such as tables or spreadsheets. Structured data has a well-defined set of rules that dictate how the data should be organized and represented, including the data types and relationships between data elements. Unstructured data refers to any data that does not have a predefined or organized format or schema. Unlike structured data, which is organized in a specific way, unstructured data can take various forms, such as text, images, audio, or video. Unstructured data can come from a variety of sources, including social media, emails, sensor data, and website content. Semi-structured data is a type of data that does not fit neatly into the traditional categories of structured and unstructured data. It has some structure but does not conform to the rigid structure of a traditional relational database. Semi-structured data is characterized by the presence of tags or metadata that provide some structure and context for the data.

The data sources 1002 are communicatively coupled to a data collector 902. The data collector 902 gathers relevant data 1004 from the data sources 1002. Once collected, the data collector 902 may use a pre-processor 1006 to make the data 1004 suitable for analysis. This involves data cleaning, transformation, and feature engineering. Data preprocessing is a critical step in ML as it directly impacts the accuracy and effectiveness of the ML model 630. The pre-processor 1006 receives the data 1004 as input, processes the data 1004, and outputs pre-processed data 1016 for storage in a database 1008. Examples for the database 1008 includes a hard drive, solid state storage, and/or random access memory (RAM).

The data collector 902 is communicatively coupled to a model trainer module 904. The model trainer module 904 performs AI/ML model training, validation, and testing which may generate model performance metrics as part of the model testing procedure. The model trainer module 904 receives the pre-processed data 1016 as input 1010 or via the database 1008. The model trainer module 904 implements a suitable ML algorithm 1024 to train an ML model 630 on a set of training data 1026 from the pre-processed data 1016. The training process involves feeding the pre-processed data 1016 into the ML algorithm 1024 to produce or optimize an ML model 630. The training process adjusts its parameters until it achieves an initial level of satisfactory performance.

The model trainer module 904 is communicatively coupled to a model evaluator module 906. After an ML model 630 is trained, the ML model 630 needs to be evaluated to assess its performance. This is done using various metrics such as accuracy, precision, recall, and F1 score. The model trainer module 904 outputs the ML model 630, which is received as input 1010 or from the database 1008. The model evaluator module 906 receives the ML model 630 as input 1012, and it initiates an evaluation process to measure performance of the ML model 630. The evaluation process includes providing feedback 1018 to the model trainer module 904. The model trainer module 904 re-trains the ML model 630 to improve performance in an iterative manner.

The model evaluator module 906 is communicatively coupled to a model inferencer module 908. The model inferencer module 908 provides AI/ML model inference output (e.g., inferences, predictions or decisions). Once the ML model 630 is trained and evaluated, it is deployed in a production environment where it is used to make predictions on new data. The model inferencer module 908 receives the evaluated ML model 630 as input 1014. The model inferencer module 908 uses the evaluated ML model 630 to produce insights or predictions on real data, which is deployed as a final production ML model 630. The inference output of the ML model 630 is use case specific. The model inferencer module 908 also performs model monitoring and maintenance, which involves continuously monitoring performance of the ML model 630 in the production environment and making any necessary updates or modifications to maintain its accuracy and effectiveness. The model inferencer module 908 provides feedback 1018 to the data collector 902 to train or re-train the ML model 630. The feedback 1018 includes model performance feedback information, which is used for monitoring and improving performance of the ML model 630.

Some or all of the model inferencer module 908 is implemented by various actors 1022 in the artificial intelligence architecture 1000, including the ML model 630 of the inferencing device 604, for example. The actors 1022 use the deployed ML model 630 on new data to make inferences or predictions for a given task, and output an insight 1032. The actors 1022 implement the model inferencer module 908 locally, or remotely receives outputs from the model inferencer module 908 in a distributed computing manner. The actors 1022 trigger actions directed to other entities or to itself. The actors 1022 provide feedback 1020 to the data collector 902 via the model inferencer module 908. The feedback 1020 comprise data needed to derive training data, inference data or to monitor the performance of the ML model 630 and its impact to the network through updating of key performance indicators (KPIs) and performance counters.

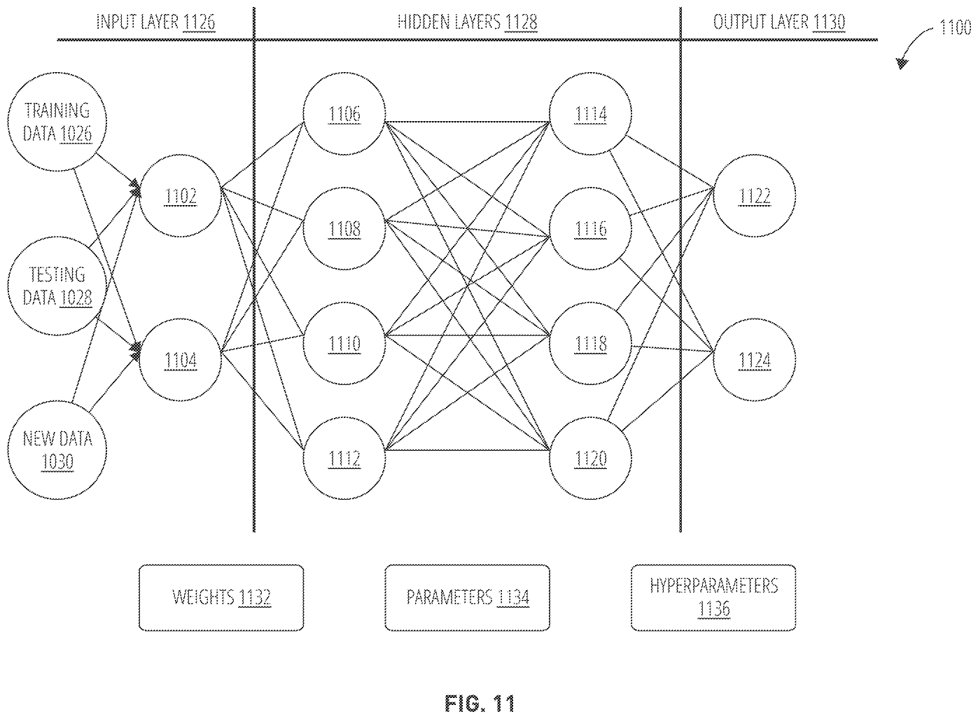

As previously described with reference to FIGS. 1, 2, the systems 600, 900 implement some or all of the artificial intelligence architecture 1000 to support various use cases and solutions for various AI/ML tasks. In various embodiments, the training device 914 of the apparatus 900 uses the artificial intelligence architecture 1000 to generate and train the ML model 630 for use by the inferencing device 604 for the system 600. In one embodiment, for example, the training device 914 may train the ML model 630 as a neural network, as described in more detail with reference to FIG. 11. Other use cases and solutions for AI/ML are possible as well, and embodiments are not limited in this context.

FIG. 11 illustrates an embodiment of an artificial neural network 1100. Neural networks, also known as artificial neural networks (ANNs) or simulated neural networks (SNNs), are a subset of machine learning and are at the core of deep learning algorithms. Their name and structure are inspired by the human brain, mimicking the way that biological neurons signal to one another.

Artificial neural network 1100 comprises multiple node layers, containing an input layer 1126, one or more hidden layers 1128, and an output layer 1130. Each layer comprises one or more nodes, such as nodes 1102 to 1124. As depicted in FIG. 11, for example, the input layer 1126 has nodes 1102, 1104. The artificial neural network 1100 has two hidden layers 1128, with a first hidden layer having nodes 1106, 1108, 1110 and 1112, and a second hidden layer having nodes 1114, 1116, 1118 and 1120. The artificial neural network 1100 has an output layer 1130 with nodes 1122, 1124. Each node 1102 to 1124 comprises a processing element (PE), or artificial neuron, that connects to another and has an associated weight and threshold. If the output of any individual node is above the specified threshold value, that node is activated, sending data to the next layer of the network. Otherwise, no data is passed along to the next layer of the network.

In general, artificial neural network 1100 relies on training data 1026 to learn and improve accuracy over time. However, once the artificial neural network 1100 is fine-tuned for accuracy, and tested on testing data 1028, the artificial neural network 1100 is ready to classify and cluster new data 1030 at a high velocity. Tasks in speech recognition or image recognition can take minutes versus hours when compared to the manual identification by human experts.

Each individual node 1102 to 424 is a linear regression model, composed of input data, weights, a bias (or threshold), and an output. The linear regression model may have a formula similar to Equation (1), as follows:

$$\sum wixi + bias = w 1 x 1 + w 2 x 2 + w3x 3 + bias \\ output = f ( x ) = 1 if \sum w 1 x 1 + b >= 0 ; \\ 0 if \sum w 1 x 1 + b < 0 \qquad EQUATION ( 1 )$$

Once an input layer 1126 is determined, a set of weights 1132 are assigned. The weights 1132 help determine the importance of any given variable, with larger ones contributing more significantly to the output compared to other inputs. All inputs are then multiplied by their respective weights and then summed. Afterward, the output is passed through an activation function, which determines the output. If that output exceeds a given threshold, it “fires” (or activates) the node, passing data to the next layer in the network. This results in the output of one node becoming in the input of the next node. The process of passing data from one layer to the next layer defines the artificial neural network 1100 as a feedforward network.

In one embodiment, the artificial neural network 1100 leverages sigmoid neurons, which are distinguished by having values between 0 and 1. Since the artificial neural network 1100 behaves similarly to a decision tree, cascading data from one node to another, having x values between 0 and 1 will reduce the impact of any given change of a single variable on the output of any given node, and subsequently, the output of the artificial neural network 1100.

The artificial neural network 1100 has many practical use cases, like image recognition, speech recognition, text recognition or classification. The artificial neural network 1100 leverages supervised learning, or labeled datasets, to train the algorithm. As the model is trained, its accuracy is measured using a cost (or loss) function. This is also commonly referred to as the mean squared error (MSE). An example of a cost function is shown in Equation (2), as follows:

$$Cost Function = M S E = \frac{1}{2 m} {\sum }_{i = 1}^{m} {( {\hat{y}}_{i} - {y}_{i} )}^{2} \to MIN \qquad EQUATION ( 2 )$$

Where i represents the index of the sample, y-hat is the predicted outcome, y is the actual value, and m is the number of samples.

Ultimately, the goal is to minimize the cost function to ensure correctness of fit for any given observation. As the model adjusts its weights and bias, it uses the cost function and reinforcement learning to reach the point of convergence, or the local minimum. The process in which the algorithm adjusts its weights is through gradient descent, allowing the model to determine the direction to take to reduce errors (or minimize the cost function). With each training example, the parameters 1134 of the model adjust to gradually converge at the minimum.

In one embodiment, the artificial neural network 1100 is feedforward, meaning it flows in one direction only, from input to output. In one embodiment, the artificial neural network 1100 uses backpropagation. Backpropagation is when the artificial neural network 1100 moves in the opposite direction from output to input. Backpropagation allows calculation and attribution of errors associated with each neuron 1102 to 1124, thereby allowing adjustment to fit the parameters 1134 of the ML model 630 appropriately.

The artificial neural network 1100 is implemented as different neural networks depending on a given task. Neural networks are classified into different types, which are used for different purposes. In one embodiment, the artificial neural network 1100 is implemented as a feedforward neural network, or multi-layer perceptrons (MLPs), comprised of an input layer 1126, hidden layers 1128, and an output layer 1130. While these neural networks are also commonly referred to as MLPs, they are actually comprised of sigmoid neurons, not perceptrons, as most real-world problems are nonlinear. Trained data 1004 usually is fed into these models to train them, and they are the foundation for computer vision, natural language processing, and other neural networks. In one embodiment, the artificial neural network 1100 is implemented as a convolutional neural network (CNN). A CNN is similar to feedforward networks, but usually utilized for image recognition, pattern recognition, and/or computer vision. These networks harness principles from linear algebra, particularly matrix multiplication, to identify patterns within an image. In one embodiment, the artificial neural network 1100 is implemented as a recurrent neural network (RNN). A RNN is identified by feedback loops. The RNN learning algorithms are primarily leveraged when using time-series data to make predictions about future outcomes, such as stock market predictions or sales forecasting. The artificial neural network 1100 is implemented as any type of neural network suitable for a given operational task of system 600, and the MLP, CNN, and RNN are merely a few examples. Embodiments are not limited in this context.

The artificial neural network 1100 includes a set of associated parameters 1134. There are a number of different parameters that must be decided upon when designing a neural network. Among these parameters are the number of layers, the number of neurons per layer, the number of training iterations, and so forth. Some of the more important parameters in terms of training and network capacity are a number of hidden neurons parameter, a learning rate parameter, a momentum parameter, a training type parameter, an Epoch parameter, a minimum error parameter, and so forth.

In some cases, the artificial neural network 1100 is implemented as a deep learning neural network. The term deep learning neural network refers to a depth of layers in a given neural network. A neural network that has more than three layers—which would be inclusive of the inputs and the output—can be considered a deep learning algorithm. A neural network that only has two or three layers, however, may be referred to as a basic neural network. A deep learning neural network may tune and optimize one or more hyperparameters 1136. A hyperparameter is a parameter whose values are set before starting the model training process. Deep learning models, including convolutional neural network (CNN) and recurrent neural network (RNN) models can have anywhere from a few hyperparameters to a few hundred hyperparameters. The values specified for these hyperparameters impacts the model learning rate and other regulations during the training process as well as final model performance. A deep learning neural network uses hyperparameter optimization algorithms to automatically optimize models. The algorithms used include Random Search, Tree-structured Parzen Estimator (TPE) and Bayesian optimization based on the Gaussian process. These algorithms are combined with a distributed training engine for quick parallel searching of the optimal hyperparameter values.

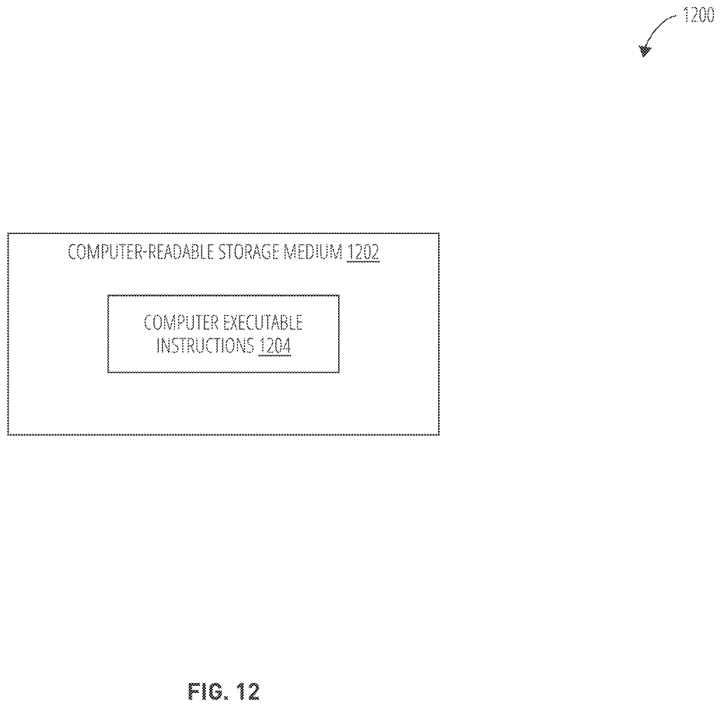

FIG. 12 illustrates an apparatus 1200. Apparatus 1200 comprises any non-transitory computer-readable storage medium 1202 or machine-readable storage medium, such as an optical, magnetic or semiconductor storage medium. In various embodiments, apparatus 1200 comprises an article of manufacture or a product. In some embodiments, the computer-readable storage medium 1202 stores computer executable instructions with which one or more processing devices or processing circuitry can execute. For example, computer executable instructions 1204 includes instructions to implement operations described with respect to any logic flows described herein. Examples of computer-readable storage medium 1202 or machine-readable storage medium include any tangible media capable of storing electronic data, including volatile memory or non-volatile memory, removable or non-removable memory, erasable or non-erasable memory, writeable or re-writeable memory, and so forth. Examples of computer executable instructions 1204 include any suitable type of code, such as source code, compiled code, interpreted code, executable code, static code, dynamic code, object-oriented code, visual code, and the like.

FIG. 13 illustrates an embodiment of a computing architecture 1300. Computing architecture 1300 is a computer system with multiple processor cores such as a distributed computing system, supercomputer, high-performance computing system, computing cluster, mainframe computer, mini-computer, client-server system, personal computer (PC), workstation, server, portable computer, laptop computer, tablet computer, handheld device such as a personal digital assistant (PDA), or other device for processing, displaying, or transmitting information. Similar embodiments may comprise, e.g., entertainment devices such as a portable music player or a portable video player, a smart phone or other cellular phone, a telephone, a digital video camera, a digital still camera, an external storage device, or the like. Further embodiments implement larger scale server configurations. In other embodiments, the computing architecture 1300 has a single processor with one core or more than one processor. Note that the term “processor” refers to a processor with a single core or a processor package with multiple processor cores. In at least one embodiment, the computing architecture 1300 is representative of the components of the system 600. More generally, the computing architecture 1300 is configured to implement all logic, systems, logic flows, methods, apparatuses, and functionality described herein with reference to previous figures.

As used in this application, the terms “system” and “component” and “module” are intended to refer to a computer-related entity, either hardware, a combination of hardware and software, software, or software in execution, examples of which are provided by the exemplary computing architecture 1300. For example, a component is, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server are a component. One or more components reside within a process and/or thread of execution, and a component is localized on one computer and/or distributed between two or more computers. Further, components are communicatively coupled to each other by various types of communications media to coordinate operations. The coordination involves the uni-directional or bi-directional exchange of information. For instance, the components communicate information in the form of signals communicated over the communications media. The information is implemented as signals allocated to various signal lines. In such allocations, each message is a signal. Further embodiments, however, alternatively employ data messages. Such data messages may be sent across various connections. Exemplary connections include parallel interfaces, serial interfaces, and bus interfaces.

As shown in FIG. 13, computing architecture 1300 comprises a system-on-chip (SoC) 1302 for mounting platform components. System-on-chip (SoC) 1302 is a point-to-point (P2P) interconnect platform that includes a first processor 1304 and a second processor 1306 coupled via a point-to-point interconnect 1370 such as an Ultra Path Interconnect (UPI). In other embodiments, the computing architecture 1300 is another bus architecture, such as a multi-drop bus. Furthermore, each of processor 1304 and processor 1306 are processor packages with multiple processor cores including core(s) 1308 and core(s) 1310, respectively. While the computing architecture 1300 is an example of a two-socket (2S) platform, other embodiments include more than two sockets or one socket. For example, some embodiments include a four-socket (4S) platform or an eight-socket (8S) platform. Each socket is a mount for a processor and may have a socket identifier. Note that the term platform refers to a motherboard with certain components mounted such as the processor 1304 and chipset 1332. Some platforms include additional components and some platforms include sockets to mount the processors and/or the chipset. Furthermore, some platforms do not have sockets (e.g. SoC, or the like). Although depicted as a SoC 1302, one or more of the components of the SoC 1302 are included in a single die package, a multi-chip module (MCM), a multi-die package, a chiplet, a bridge, and/or an interposer. Therefore, embodiments are not limited to a SoC.

The processor 1304 and processor 1306 are any commercially available processors, including without limitation an Intel® Celeron®, Core®, Core (2) Duo®, Itanium®, Pentium®, Xeon®, and XScale® processors; AMD® Athlon®, Duron® and Opteron® processors; ARM® application, embedded and secure processors; IBM® and Motorola® DragonBall® and PowerPC® processors; IBM and Sony® Cell processors; and similar processors. Dual microprocessors, multi-core processors, and other multi-processor architectures are also employed as the processor 1304 and/or processor 1306. Additionally, the processor 1304 need not be identical to processor 1306.

Processor 1304 includes an integrated memory controller (IMC) 1320 and point-to-point (P2P) interface 1324 and P2P interface 1328. Similarly, the processor 1306 includes an IMC 1322 as well as P2P interface 1326 and P2P interface 1330. IMC 1320 and IMC 1322 couple the processor 1304 and processor 1306, respectively, to respective memories (e.g., memory 1316 and memory 1318). Memory 1316 and memory 1318 are portions of the main memory (e.g., a dynamic random-access memory (DRAM)) for the platform such as double data rate type 4 (DDR4) or type 5 (DDR5) synchronous DRAM (SDRAM). In the present embodiment, the memory 1316 and the memory 1318 locally attach to the respective processors (i.e., processor 1304 and processor 1306). In other embodiments, the main memory couple with the processors via a bus and shared memory hub. Processor 1304 includes registers 1312 and processor 1306 includes registers 1314.

Computing architecture 1300 includes chipset 1332 coupled to processor 1304 and processor 1306. Furthermore, chipset 1332 are coupled to storage device 1350, for example, via an interface (I/F) 1338. The I/F 1338 may be, for example, a Peripheral Component Interconnect-enhanced (PCIe) interface, a Compute Express Link® (CXL) interface, or a Universal Chiplet Interconnect Express (UCIe) interface. Storage device 1350 stores instructions executable by circuitry of computing architecture 1300 (e.g., processor 1304, processor 1306, GPU 1348, accelerator 1354, vision processing unit 1356, or the like). For example, storage device 1350 can store instructions for the client device 602, the client device 606, the inferencing device 604, the training device 914, or the like.

Processor 1304 couples to the chipset 1332 via P2P interface 1328 and P2P 1334 while processor 1306 couples to the chipset 1332 via P2P interface 1330 and P2P 1336. Direct media interface (DMI) 1376 and DMI 1378 couple the P2P interface 1328 and the P2P 1334 and the P2P interface 1330 and P2P 1336, respectively. DMI 1376 and DMI 1378 is a high-speed interconnect that facilitates, e.g., eight Giga Transfers per second (GT/s) such as DMI 3.0. In other embodiments, the processor 1304 and processor 1306 interconnect via a bus.

The chipset 1332 comprises a controller hub such as a platform controller hub (PCH). The chipset 1332 includes a system clock to perform clocking functions and include interfaces for an I/O bus such as a universal serial bus (USB), peripheral component interconnects (PCIs), CXL interconnects, UCIe interconnects, interface serial peripheral interconnects (SPIs), integrated interconnects (I2Cs), and the like, to facilitate connection of peripheral devices on the platform. In other embodiments, the chipset 1332 comprises more than one controller hub such as a chipset with a memory controller hub, a graphics controller hub, and an input/output (I/O) controller hub.

In the depicted example, chipset 1332 couples with a trusted platform module (TPM) 1344 and UEFI, BIOS, FLASH circuitry 1346 via I/F 1342. The TPM 1344 is a dedicated microcontroller designed to secure hardware by integrating cryptographic keys into devices. The UEFI, BIOS, FLASH circuitry 1346 may provide pre-boot code. The I/F 1342 may also be coupled to a network interface circuit (NIC) 1380 for connections off-chip.

Furthermore, chipset 1332 includes the I/F 1338 to couple chipset 1332 with a high-performance graphics engine, such as, graphics processing circuitry or a graphics processing unit (GPU) 1348. In other embodiments, the computing architecture 1300 includes a flexible display interface (FDI) (not shown) between the processor 1304 and/or the processor 1306 and the chipset 1332. The FDI interconnects a graphics processor core in one or more of processor 1304 and/or processor 1306 with the chipset 1332.

The computing architecture 1300 is operable to communicate with wired and wireless devices or entities via the network interface (NIC) 180 using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, 3G, 4G, LTE wireless technologies, among others. Thus, the communication is a predefined structure as with a conventional network or simply an ad hoc communication between at least two devices. Wi-Fi networks use radio technologies called IEEE 802.11x (a, b, g, n, ac, ax, etc.) to provide secure, reliable, fast wireless connectivity. A Wi-Fi network is used to connect computers to each other, to the Internet, and to wired networks (which use IEEE 802.3-related media and functions).

Additionally, accelerator 1354 and/or vision processing unit 1356 are coupled to chipset 1332 via I/F 1338. The accelerator 1354 is representative of any type of accelerator device (e.g., a data streaming accelerator, cryptographic accelerator, cryptographic co-processor, an offload engine, etc.). One example of an accelerator 1354 is the Intel® Data Streaming Accelerator (DSA). The accelerator 1354 is a device including circuitry to accelerate copy operations, data encryption, hash value computation, data comparison operations (including comparison of data in memory 1316 and/or memory 1318), and/or data compression. Examples for the accelerator 1354 include a USB device, PCI device, PCIe device, CXL device, UCIe device, and/or an SPI device. The accelerator 1354 also includes circuitry arranged to execute machine learning (ML) related operations (e.g., training, inference, etc.) for ML models. Generally, the accelerator 1354 is specially designed to perform computationally intensive operations, such as hash value computations, comparison operations, cryptographic operations, and/or compression operations, in a manner that is more efficient than when performed by the processor 1304 or processor 1306. Because the load of the computing architecture 1300 includes hash value computations, comparison operations, cryptographic operations, and/or compression operations, the accelerator 1354 greatly increases performance of the computing architecture 1300 for these operations.

The accelerator 1354 includes one or more dedicated work queues and one or more shared work queues (each not pictured). Generally, a shared work queue is configured to store descriptors submitted by multiple software entities. The software is any type of executable code, such as a process, a thread, an application, a virtual machine, a container, a microservice, etc., that share the accelerator 1354. For example, the accelerator 1354 is shared according to the Single Root I/O virtualization (SR-IOV) architecture and/or the Scalable I/O virtualization (S-IOV) architecture. Embodiments are not limited in these contexts. In some embodiments, software uses an instruction to atomically submit the descriptor to the accelerator 1354 via a non-posted write (e.g., a deferred memory write (DMWr)). One example of an instruction that atomically submits a work descriptor to the shared work queue of the accelerator 1354 is the ENQCMD command or instruction (which may be referred to as “ENQCMD” herein) supported by the Intel® Instruction Set Architecture (ISA). However, any instruction having a descriptor that includes indications of the operation to be performed, a source virtual address for the descriptor, a destination virtual address for a device-specific register of the shared work queue, virtual addresses of parameters, a virtual address of a completion record, and an identifier of an address space of the submitting process is representative of an instruction that atomically submits a work descriptor to the shared work queue of the accelerator 1354. The dedicated work queue may accept job submissions via commands such as the movdir64b instruction.

Various I/O devices 1360 and display 1352 couple to the bus 1372, along with a bus bridge 1358 which couples the bus 1372 to a second bus 1374 and an I/F 1340 that connects the bus 1372 with the chipset 1332. In one embodiment, the second bus 1374 is a low pin count (LPC) bus. Various input/output (I/O) devices couple to the second bus 1374 including, for example, a keyboard 1362, a mouse 1364 and communication devices 1366.

Furthermore, an audio I/O 1368 couples to second bus 1374. Many of the I/O devices 1360 and communication devices 1366 reside on the system-on-chip (SoC) 1302 while the keyboard 1362 and the mouse 1364 are add-on peripherals. In other embodiments, some or all the I/O devices 1360 and communication devices 1366 are add-on peripherals and do not reside on the system-on-chip (SoC) 1302.

FIG. 14 illustrates a block diagram of an exemplary communications architecture 1400 suitable for implementing various embodiments as previously described. The communications architecture 1400 includes various common communications elements, such as a transmitter, receiver, transceiver, radio, network interface, baseband processor, antenna, amplifiers, filters, power supplies, and so forth. The embodiments, however, are not limited to implementation by the communications architecture 1400.

As shown in FIG. 14, the communications architecture 1400 includes one or more clients 1402 and servers 1404. The clients 1402 and the servers 1404 are operatively connected to one or more respective client data stores 1408 and server data stores 1410 that can be employed to store information local to the respective clients 1402 and servers 1404, such as cookies and/or associated contextual information.

The clients 1402 and the servers 1404 communicate information between each other using a communication framework 1406. The communication framework 1406 implements any well-known communications techniques and protocols. The communication framework 1406 is implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communication framework 1406 implements various network interfaces arranged to accept, communicate, and connect to a communications network. A network interface is regarded as a specialized form of an input output interface. Network interfaces employ connection protocols including without limitation direct connect, Ethernet (e.g., thick, thin, twisted pair 10/600/1000 Base T, and the like), token ring, wireless network interfaces, cellular network interfaces, IEEE 802.11 network interfaces, IEEE 802.16 network interfaces, IEEE 802.20 network interfaces, and the like. Further, multiple network interfaces are used to engage with various communications network types. For example, multiple network interfaces are employed to allow for the communication over broadcast, multicast, and unicast networks. Should processing requirements dictate a greater amount speed and capacity, distributed network controller architectures are similarly employed to pool, load balance, and otherwise increase the communicative bandwidth required by clients 1402 and the servers 1404. A communications network is any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

The various elements of the devices as previously described with reference to the figures include various hardware elements, software elements, or a combination of both. Examples of hardware elements include devices, logic devices, components, processors, microprocessors, circuits, processors, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. However, determining whether an embodiment is implemented using hardware elements and/or software elements varies in accordance with any number of factors, such as desired computational rate, power levels, heat tolerances, processing cycle budget, input data rates, output data rates, memory resources, data bus speeds and other design or performance constraints, as desired for a given implementation.

One or more aspects of at least one embodiment are implemented by representative instructions stored on a machine-readable medium which represents various logic within the processor, which when read by a machine causes the machine to fabricate logic to perform the techniques described herein. Such representations, known as “intellectual property (IP) cores” are stored on a tangible, machine readable medium and supplied to various customers or manufacturing facilities to load into the fabrication machines that make the logic or processor. Some embodiments are implemented, for example, using a machine-readable medium or article which may store an instruction or a set of instructions that, when executed by a machine, causes the machine to perform a method and/or operations in accordance with the embodiments. Such a machine includes, for example, any suitable processing platform, computing platform, computing device, processing device, computing system, processing system, processing devices, computer, processor, or the like, and is implemented using any suitable combination of hardware and/or software. The machine-readable medium or article includes, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions include any suitable type of code, such as source code, compiled code, interpreted code, executable code, static code, dynamic code, encrypted code, and the like, implemented using any suitable high-level, low-level, object-oriented, visual, compiled and/or interpreted programming language.

As utilized herein, terms “component,” “system,” “interface,” and the like are intended to refer to a computer-related entity, hardware, software (e.g., in execution), and/or firmware. For example, a component is a processor (e.g., a microprocessor, a controller, or other processing device), a process running on a processor, a controller, an object, an executable, a program, a storage device, a computer, a tablet PC and/or a user equipment (e.g., mobile phone, etc.) with a processing device. By way of illustration, an application running on a server and the server is also a component. One or more components reside within a process, and a component is localized on one computer and/or distributed between two or more computers. A set of elements or a set of other components are described herein, in which the term “set” can be interpreted as “one or more.”

Further, these components execute from various computer readable storage media having various data structures stored thereon such as with a module, for example. The components communicate via local and/or remote processes such as in accordance with a signal having one or more data packets (e.g., data from one component interacting with another component in a local system, distributed system, and/or across a network, such as, the Internet, a local area network, a wide area network, or similar network with other systems via the signal).

As another example, a component is an apparatus with specific functionality provided by mechanical parts operated by electric or electronic circuitry, in which the electric or electronic circuitry is operated by a software application or a firmware application executed by one or more processors. The one or more processors are internal or external to the apparatus and execute at least a part of the software or firmware application. As yet another example, a component is an apparatus that provides specific functionality through electronic components without mechanical parts; the electronic components include one or more processors therein to execute software and/or firmware that confer(s), at least in part, the functionality of the electronic components.

Use of the word exemplary is intended to present concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. Furthermore, to the extent that the terms “including”, “includes”, “having”, “has”, “with”, or variants thereof are used in either the detailed description or the claims, such terms are intended to be inclusive in a manner similar to the term “comprising.” Additionally, in situations wherein one or more numbered items are discussed (e.g., a “first X”, a “second X”, etc.), in general the one or more numbered items may be distinct or they may be the same, although in some situations the context may indicate that they are distinct or that they are the same.

As used herein, the term “circuitry” may refer to, be part of, or include a circuit, an integrated circuit (IC), a monolithic IC, a discrete circuit, a hybrid integrated circuit (HIC), an Application Specific Integrated Circuit (ASIC), an electronic circuit, a logic circuit, a microcircuit, a hybrid circuit, a microchip, a chip, a chiplet, a chipset, a multi-chip module (MCM), a semiconductor die, a system on a chip (SoC), a processor (shared, dedicated, or group), a processor circuit, a processing circuit, or associated memory (shared, dedicated, or group) operably coupled to the circuitry that execute one or more software or firmware programs, a combinational logic circuit, or other suitable hardware components that provide the described functionality. In some embodiments, the circuitry is implemented in, or functions associated with the circuitry are implemented by, one or more software or firmware modules. In some embodiments, circuitry includes logic, at least partially operable in hardware. It is noted that hardware, firmware and/or software elements may be collectively or individually referred to herein as “logic” or “circuit.”

Some embodiments are described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Moreover, unless otherwise noted the features described above are recognized to be usable together in any combination. Thus, any features discussed separately can be employed in combination with each other unless it is noted that the features are incompatible with each other.

Some embodiments are presented in terms of program procedures executed on a computer or network of computers. A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein, which form part of one or more embodiments. Rather, the operations are machine operations. Useful machines for performing operations of various embodiments include general purpose digital computers or similar devices.

Some embodiments are described using the expression “coupled” and “connected” along with their derivatives. These terms are not necessarily intended as synonyms for each other. For example, some embodiments are described using the terms “connected” and/or “coupled” to indicate that two or more elements are in direct physical or electrical contact with each other. The term “coupled,” however, also means that two or more elements are not in direct contact with each other, but yet still co-operate or interact with each other.

Various embodiments also relate to apparatus or systems for performing these operations. This apparatus is specially constructed for the required purpose or it comprises a general purpose computer as selectively activated or reconfigured by a computer program stored in the computer. The procedures presented herein are not inherently related to a particular computer or other apparatus. Various general purpose machines are used with programs written in accordance with the teachings herein, or it proves convenient to construct more specialized apparatus to perform the required method steps. The required structure for a variety of these machines are apparent from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

The following examples pertain to further embodiments, from which numerous permutations and configurations will be apparent.

What is claimed is:

1. A method, comprising:
receiving activity data associated with a user from a device;
generating a touchpoint embedding and a decision embedding using a graph neural network (GNN) model based on the activity data, the GNN model trained using a knowledge graph;
predicting a touchpoint using a first classifier based on the touchpoint embedding;
predicting a decision stage using a second classifier based on the decision embedding; and
generating personalized content for the touchpoint based on the decision stage using a large language model (LLM).

2. The method of claim 1, comprising presenting the personalized content for the touchpoint on an electronic display of the device.

3. The method of claim 1, comprising:
retrieving content from a database based on the touchpoint and the decision stage;
constructing a prompt for the LLM to regenerate the content; and
generating the personalized content based on the regenerated content from the LLM.

4. The method of claim 1, wherein the activity data is graph-structured data for the knowledge graph, the graph-structured data comprising a user node, a touchpoint node, an event node, and a set of edges between the user node, the touchpoint node, and the event node.

5. The method of claim 1, wherein the touchpoint embedding is a vector comprising values representing a relationship between a user node, a touchpoint node, and an edge between the user node and the touchpoint node.

6. The method of claim 1, wherein the decision embedding is a vector comprising values representing a relationship between a user node, an event node, and an edge between the user node and the event node.

7. The method of claim 1, comprising:
detecting a transaction associated with the user from the device; and
updating the knowledge graph with graph-structured data based on the activity data associated with the user after the transaction.

8. A system comprising:
a memory component; and
one or more processing devices coupled to the memory component, the one or more processing devices to perform operations comprising:
accessing, by a model trainer module, a training dataset to train a graph neural network (GNN) model, the training dataset comprising multiple datapoints, each datapoint comprising samples from a knowledge graph, each sample comprising a user node, a touch point node, an event node, and a set of edges between the user node, the touchpoint node, or the event node;
generating, by the GNN model, a touchpoint embedding based on a first datapoint from the training dataset;
generating, by the GNN model, a decision embedding based on a second datapoint from the training dataset;
evaluating, by the model trainer module, the touchpoint embedding and the decision embedding using labels associated with the first datapoint and the second datapoint, respectively;
updating, by the model trainer module, parameters for the GNN model using a loss function and optimization algorithm based on evaluation results to train the GNN model.

9. The system of claim 8, wherein the touchpoint embedding comprises a vector with values representing a relationship between a user node, a touchpoint node, and an edge between the user node and the touchpoint node.

10. The system of claim 8, wherein the decision embedding comprises a vector with values representing a relationship between a user node, an event node, and an edge between the user node and the event node.

11. The system of claim 8, the one or more processing devices to perform operations comprising evaluating, by a model evaluator module, the trained GNN model using a testing dataset comprising datapoints to test the GNN model.

12. The system of claim 8, the one or more processing devices to perform operations comprising re-training, by the model trainer module, the trained GNN model using feedback information.

13. The system of claim 8, the one or more processing devices to perform operations comprising:
detecting a transaction from activity data associated with a user from a device;
encoding the knowledge graph with a new user node representing the user, a new event node representing the transaction, and a new edge between the new user node and the new event node;
generating a new datapoint for the training dataset; and
re-training the GNN model using the new datapoint.

14. A non-transitory computer-readable medium storing executable instructions, which when executed by one or more processing devices, cause the one or more processing devices to perform operations comprising:
receiving activity data associated with a user from a device;
generating a touchpoint embedding and a decision embedding using a graph neural network (GNN) model based on the activity data, the GNN model trained using a knowledge graph;
predicting a touchpoint using a first classifier based on the touchpoint embedding;
predicting a decision stage using a second classifier based on the decision embedding; and
generating personalized content for the touchpoint based on the decision stage using a large language model (LLM), the personalized content comprising a multimedia message in a natural language.

15. The computer-readable storage medium of claim 14, comprising presenting the personalized content for the touchpoint on an electronic display of the device.

16. The computer-readable storage medium of claim 14, comprising:
retrieving content from a database based on the touchpoint and the decision stage;
constructing a prompt for the LLM to regenerate the content; and
generating the personalized content based on the regenerated content from the LLM.

17. The computer-readable storage medium of claim 14, wherein the activity data is graph-structured data for the knowledge graph, the graph-structured data comprising a user node, a touchpoint node, an event node, and a set of edges between the user node, the touchpoint node, and the event node.

18. The computer-readable storage medium of claim 14, wherein the touchpoint embedding is a vector comprising values representing a relationship between a user node, a touchpoint node, and an edge between the user node and the touchpoint node.

19. The computer-readable storage medium of claim 14, wherein the decision embedding is a vector comprising values representing a relationship between a user node, an event node, and an edge between the user node and the event node.

20. The computer-readable storage medium of claim 14, comprising:
detecting a transaction associated with the user from the device; and
updating the knowledge graph with graph-structured data based on the activity data associated with the user after the transaction.
